(19) United States
(12) Patent Application Publication
(10) Pub. No.: US 2014/0093727 A1
(43) Pub. Date: Apr. 3, 2014

(54) SCANNED, PULSED ELECTRON-BEAM POLYMERIZATION

(71) Applicant: 3M INNOVATIVE PROPERTIES COMPANY, St. Paul, MN (US)

(72) Inventors: Karl B. Richter, St. Paul, MN (US); Douglas S. Dunn, Maplewood, MN (US); Douglas E. Weiss, Overland Park, KS (US)

(73) Assignee: 3M INNOVATIVE PROPERTIES COMPANY, St. Paul, MN (US)

(21) Appl. No.: 14/119,040

(22) PCT Filed: May 22, 2012
(86) PCT No.: PCT/US2012/038951

§ 371 Date: Nov. 20, 2013

Related U.S. Application Data
(60) Provisional application No. 61/490,721, filed on May 27, 2011.

(51) Int. Cl. C09D 133/10; C09J 133/10

(52) U.S. Cl. CPC C09D 133/10; C09J 133/10
USPC 428/355 R; 427/496; 427/492; 524/561

(57) ABSTRACT

A method including: a. coating at least a portion of at least one major surface of a substrate with a polymerizable composition to obtain a coated surface; b. initiating polymerization of the polymerizable composition by scanning a first electron-beam focused on the coated surface across at least a portion of the coated surface, thereby irradiating the coated surface at a frequency selected to achieve an exposure duration of greater than 0 and no greater than 10 microseconds, and a dark time between each exposure duration of at least one millisecond, thereby producing an at least partially polymerized composition. A pressure sensitive adhesive article and a cross-linked silicone release liner made according to the method are also disclosed.

### CROSS REFERENCE TO RELATED APPLICATIONS

This application claims priority from U.S. Provisional Application Ser. No. 61/490,721, filed May 27, 2011, the disclosure of which is incorporated by reference in its/their entirety herein.

### FIELD

This disclosure relates generally to a polymerization method. The disclosure more particularly relates to a polymerization method in which monomers and/or oligomers on a substrate surface are polymerized using pulses of accelerated electrons from a rapidly scanned electron-beam.

### BACKGROUND

Electron-beams are known in the art (see e.g. U.S. Pat. Nos. 2,810,933; 5,414,267; 6,038,015; 7,256,139; and 7,348,555). Electron-beams operate by bombarding molecules with electrons. These electrons displace other electrons in the bombarded molecules, thereby creating free radicals, which may react with other molecules. Electron-beam radiation produces a high rate of free-radical initiation and may produce free radicals in all components of the system including the product itself as it is being formed (see e.g. Wilson, Radiation Chemistry of Monomers, Polymers, and Plastics, chapter 11, p. 375, New York, 1974). Because of this indiscriminate production of free radicals and high dose rates (radical flux), electron-beam radiation has generally only been used for continuous monomer (as opposed to oligomer) polymerization processes having long completion times, or to cross-link pre-formed polymers.

Pulsed electron-beams are also known in the art (see e.g. 3,144,552; 3,925,670; and U.S. Pub. Pat. App. No. 2003/0031802). Pulsed e-beams have been shown to be advantageous over continuous e-beams in carrying out monomer polymerization. Pulsed electron-beams may achieve an e-beam dose rate and current per exposure area that cannot generally be achieved simply by rapidly switching continuous e-beams on and off. However, the very high dose rates and short residence times generally required in continuous polymerization processes carried out on webs coated with polymerizable material tend to result in low conversion and short chain length for the resulting polymers forming the coating.

### SUMMARY

Exemplary embodiments of the method of the present disclosure take advantage of the special kinetic properties that result from “pulsing” a scanned electron-beam across a substrate coated with a polymerizable composition. The advantages of a scanned, pulsed e-beam may be obtained either by rapidly pulsing a discontinuous or pulsed electron-beam as it is scanned across a coated surface of a substrate, or by simulating rapid pulsing by rapidly scanning a continuous electron-beam focused on the coated surface across at least a portion of the coated surface, thereby irradiating the coated surface at a frequency selected to achieve an exposure duration of greater than 0 and no greater than 10 microseconds per scan, and a dark time between each exposure duration of at least one millisecond.

Thus, in one aspect, the present disclosure describes a polymerization method comprising:
a) coating at least a portion of at least one major surface of a substrate with a polymerizable composition to obtain a coated surface;
b) initiating polymerization of the polymerizable composition by scanning a first electron-beam focused on the coated surface across at least a portion of the coated surface, thereby irradiating the coated surface at a frequency selected to achieve an exposure duration of greater than 0 and no greater than 10 microseconds per scan, and a dark time between each exposure duration of at least one millisecond, thereby producing an at least partially polymerized composition.

In some exemplary embodiments, the method further comprises further irradiating the coated surface with a continuous beam of accelerated electrons from a continuous electron-beam source to further polymerize the at least partially polymerized composition, optionally wherein at least one of irradiating the coated surface and further irradiating the coated surface occurs at a temperature below 20° C.

In some particular exemplary embodiments, the first electron-beam is a pulsed electron-beam. Thus in further exemplary embodiments of the foregoing, a pulse rate of the first electron-beam is about 25 to about 3,000 pulses per second. In other exemplary embodiments, the first electron-beam is a continuous electron-beam. In some exemplary embodiments of any of the foregoing, the exposure (or pulse) duration is from about 0.5 to about 2 microseconds per scan. In certain such exemplary embodiments, the first electron-beam delivers an electron-beam dose per exposure (or pulse) duration between 0 and 10 Gy.

In certain exemplary embodiments, the substrate is a web moving in a down-web direction and having a width in a cross-web direction substantially orthogonal to the down-web direction, further wherein scanning the first electron-beam across at least a portion of the coated surface comprises scanning the electron-beam in the cross-web direction, scanning the electron-beam in the down-web direction, and combinations thereof.

In some exemplary embodiments of any of the foregoing, scanning the first electron-beam across the coated surface produces a plurality of irradiated regions of the polymerizable composition, optionally wherein each of the plurality of irradiated regions is surrounded by a non-irradiated region of the polymerizable composition. This may facilitate the formation of structures or features formed by the at least partially polymerized polymerizable composition on the major surface of the substrate. In further exemplary embodiments, the non-irradiated region of the polymerizable composition may be removed (e.g. by washing with a solvent which dissolves the polymerizable composition but not the at least partially polymerized composition).

In additional exemplary embodiments, the polymerizable composition comprises at least one polymerizable monomer, at least one oligomer, or a combination thereof. In some exemplary embodiments the at least one polymerizable monomer comprises a C₈₋₁₃ alkyl acrylate monomer. In certain such exemplary embodiments, the C₈₋₁₃ alkyl acrylate is selected from the group consisting of isooctyl acrylate, 2-ethylhexyl acrylate, lauryl acrylate and tridecul acrylate. In some particular exemplary embodiments, the at least one polymerizable monomer is selected from the group consisting of methyl methacrylate, isobornyl acrylate, tripropyleneglycol diacrylate, pentaerythritol triacrylate, pentaeryritol tetraacrylate, hydantoin hexacrylate, and trimethylolpropylenetriacrylate. In additional such exemplary embodiments, the polymerizable composition further comprises at least one polymerizable comonomer. In some such additional embodiments, the at least one polymerizable comonomer is selected from the group consisting of acrylic acid, isobornyl acrylate, octylacrylamide and n-vinyl pyrrolidone.

In further exemplary embodiments of any of the foregoing, the polymerizable composition further comprises a cross-linking agent. In additional exemplary embodiments of any of the foregoing, the polymerizable composition further comprises a thickener.

In any of the foregoing exemplary embodiments, the polymerizable composition is polymerized heterogeneously in a single phase. In some exemplary presently preferred embodiments, the polymerizable composition is greater than 90%, and optionally the gel percent is greater than 95%. In any of the foregoing embodiments, irradiating with pulses of accelerated electrons from a pulsed electron-beam occurs at a temperature below 20° C.

The presently disclosed method, in exemplary embodiments, enables continuous production of articles in web or roll form, for example, pressure-sensitive adhesive articles (e.g. tapes) and crosslinked silicone release liners. Exemplary embodiments of the method enable the polymerizable composition to be polymerized in a single phase and on-web. In some such embodiments, an article may be coated or otherwise fabricated while the polymerizable composition is being polymerized, thereby providing a very efficient, one-step fabrication process.

Exemplary embodiments of the present disclosure have advantages over use of other types of irradiation (e.g. gamma radiation, ultraviolet radiation, and the like), as well as a continuous e-beam or a non-scanned pulsed e-beam. One such advantage of exemplary embodiments of the present disclosure is that the polymerization process is effective for quickly and efficiently producing polymers having a sufficient cross-link density. One use for such cross-linked polymers is in a pressure-sensitive adhesive composition requiring superior peel adhesion and superior shear strength and high conversion, which does not require the use of solvents or chemical initiators for the conversion process to take place.

A second advantage of at least one exemplary embodiment of the present disclosure is that the deposition of energy by the pulses of accelerated electrons, under certain conditions (e.g. low dose/pulse and high pulse rate), is heterogeneous in nature. Heterogeneous polymerization has the effect of limiting termination reactions, which results in higher conversion values for the polymerization method.

Another advantage of at least one embodiment of the present disclosure is that the residence time needed to produce an article using the method is shorter, because of reduced terminations, than using the other methods of irradiation or a continuous beam of electrons. This means that more practical throughput rates can be achieved.

An additional advantage of at least those embodiments which use a pulsed electron-beam source is the ability to irradiate discrete regions of a polymerizable composition on a major surface of a substrate, thereby facilitating the formation of a plurality of discrete irradiated regions of the polymerizable composition wherein each of the plurality of irradiated regions is surrounded by a non-irradiated region of the polymerizable composition. This may facilitate the formation of structures or features formed by the at least partially polymerized polymerizable composition on the major surface of the substrate. This may also permit the formation of a patterned or textured surface formed by the at least partially polymerized polymerizable composition, or a surface on which three-dimensional structures are formed by the at least partially polymerizable composition (e.g. after removal of any non-polymerized polymerizable composition).

Yet another advantage of at least one embodiment of the present disclosure is that it allows for polymerization of materials with short stability times, because the process is so fast. For instance, polymerization of a mixture of two immiscible materials is possible. The mixture can be polymerized after it has been mixed and before it has a chance to phase separate. In addition, polymerization of thin layers of materials that evaporate quickly after being coated is also possible. Further, because temperature control can be practically maintained throughout the short time period necessary for polymerization, it is possible to polymerize biphase compositions with novel morphology or topology.

Another advantage in at least one exemplary embodiment over, for example, an ultraviolet radiation induced polymerization process, is that a clean and clear adhesive can be made without the use of photoinitiators or triazine residues. Also, highly pigmented adhesives can be produced that would not be able to be produced using ultraviolet (UV) radiation sources (e.g. UV curing) because highly pigmented adhesives are generally opaque to UV light.

An additional advantage of exemplary embodiments of the present disclosure is that there are fewer contaminants than with other processes. In other processes for making a pressure-sensitive adhesive, for example, catalysts or initiators are used to make the adhesive. The initiator, or parts of it, remains in the adhesive that is formed using the initiator. It is important, in the electronics industry, for example, to keep these contaminants to a minimum. When adhesives, for example, are used in or near electronics, any contaminants in the adhesives or out-gas may cause undesirable reactions in the electronics, such as corrosion. The pulsed e-beam process does not use initiators, and, therefore, eliminates this problem.

One more advantage of at least one exemplary embodiment of the present disclosure is that it is versatile. For example, the method may be used to polymerize solventless blends as well as emulsions, which may be coated on-web and then polymerized.

Various aspects and advantages of exemplary embodiments of the present disclosure have been summarized. The above Summary is not intended to describe each illustrated embodiment or every implementation of the present invention. Further features and advantages are disclosed in the embodiments that follow. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1A is a side view of an exemplary apparatus useful in practicing various exemplary embodiments of the present disclosure.

FIG. 1B is a detailed top view through 110 of FIG. 1A, showing an exemplary electron-beam transmissive window and an exemplary substrate surface over which a pulsed electron-beam has been scanned.

FIG. 2 is a graph of the monomer fractional conversion as a function of the total electron-beam dose obtained in comparative examples of pulsed electron-beam polymerization using four different pulse durations.

FIG. 3 is a graph of the monomer fractional conversion as a function of total electron-beam dose obtained in exemplary embodiments comparing scanned pulsed electron-beam polymerization with continuous electron-beam polymerization.

FIG. 4 is a graph of the monomer fractional conversion as a function of total electron-beam dose obtained in exemplary embodiments of scanned pulsed electron-beam polymerization using different dose/pulse levels.

FIG. 5 is a graph of gel percent as a function of total electron-beam dose obtained in exemplary embodiments comparing scanned pulsed electron-beam polymerization with continuous electron-beam polymerization at 165 kV.

While the above-identified drawings, which may not be drawn to scale, set forth various embodiments of the present disclosure, other embodiments are also contemplated, as noted in the Detailed Description. In all cases, this disclosure describes the presently disclosed invention by way of representation of exemplary embodiments and not by express limitations. It should be understood that numerous other modifications and embodiments can be devised by those skilled in the art, which fall within the scope and spirit of this invention.

### DETAILED DESCRIPTION

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

For the following Glossary of defined terms, these definitions shall be applied for the entire application, unless a different definition is provided in the claims or elsewhere in the specification.

### GLOSSARY

As used herein, including the claims, the term “(co)polymer” means a homopolymer or a copolymer.

As used herein, including the claims, the term “(meth)acrylic” with respect to a monomer means a vinyl-functional alkyl ester formed as the reaction product of an alcohol with an acrylic or a methacrylic acid, for example, acrylic acid or methacrylic acid. With respect to a (co)polymer, the term means a (co)polymer formed by polymerizing one or more (meth)acrylic monomers.

As used herein, including the claims, the term “syrup” is used in accordance with its conventional definition to reference compositions of one or more polymerizable monomers, oligomers and/or polymers that have coatable viscosities and do not exhibit any appreciable pressure-sensitive adhesive characteristics until cured. Such syrups typically achieve a coatable viscosity through partial polymerization or through the addition of organic or inorganic thickening agents.

As used herein, including the claims, the term “conversion” is used in accordance with its conventional industry meaning to reference the non-volatile, reacted portion of the polymerized adhesive mass (both gelled and extractable) and does not remain as a monomeric residue, moisture or decomposition fragments, and/or unreactive contaminant.

As used herein, including the claims, the term “wt %” is used in accordance with its conventional industry meaning and refers to an amount based upon the total weight of solids in the referenced composition.

As used herein, including the claims, the term “gel” refers to the non-extractable component in the converted material that constitutes an “infinite” network (one molecule).

As used herein, including the claims, the term “single phase” means that all of the components of the system or composition (i.e. monomers, oligomers, additives, solvent, etc.) exist in a single physical phase (i.e. gas, liquid or solid) and are not partitioned in any way from one another, and hence they are miscible.

As used herein, the term “conversion dose” means the dose necessary to reach a certain percentage of conversion (i.e. about 97%) from monomers to polymers during a polymerization process.

### Electron-Beam Sources

Electron-beams (e-beams) are generally produced by applying high voltage to tungsten wire filaments retained between a repeller plate and an extractor grid within a vacuum chamber maintained at about 10⁻⁶ Torr. The filaments are heated at high current to produce electrons. The electrons are guided and accelerated by the repeller plate and extractor grid towards a thin window of metal foil. The accelerated electrons, traveling at speeds in excess of 10⁷ meters/second (m/sec) and possessing about 70 to 300 kilo-electron volts (keV), pass out of the vacuum chamber through the foil window and penetrate into whatever material is positioned immediately below the window.

The quantity of electrons generated is directly related to the extractor grid voltage. As extractor grid voltage is increased, the quantity of electrons drawn from the tungsten wire filaments increases. E-beam processing can be extremely precise when under computer control, such that an exact dose and dose rate of electrons can be directed against what is desired to be polymerized.

Electron-beam generators that produce pulses of accelerated electrons are commercially available. One example is an e-beam from North Star Research Corp. (NSRC) in Albuquerque, N. Mex. Another example of an e-beam machine that allows for pulse rate selection is the PYXIS 7000 (PYXIS), which is sold by Biosterile, Fort Wayne, Ind.

For any given piece of equipment and irradiation sample location, the dosage delivered can be measured in accordance with ASTM E-1275 entitled “Practice for Use of a Radiochromic Film Dosimetry System.” By altering extractor grid voltage, repetition rate, beam area coverage and/or distance to the source, various dose rates can be obtained.

### Electron-Beam Polymerization

Electron-beam irradiation has been used to polymerize multifunctional monomers and/or multifunctional oligomers to make hard, scratch-resistant crosslinked coatings. Electron-beam (e-beam) irradiation has also been used to cross-link a variety of different polymers for purposes of improving various properties such as resistance to melting, tensile strength and shear strength. However, the use of e-beam polymerization has generally been limited due to the inherent tendency of e-beam radiation to produce short-chain, branched, highly cross-linked polymeric structures.

This phenomenon is manifested by the tendency for e-beam polymerized pressure-sensitive adhesives to exhibit pop-off failures, frequently accompanied by low peel strength. A second limitation observed with typical e-beam polymerization techniques is a substantial concentration of residuals (e.g., unreacted monomers) remaining in the resultant polymerized product (i.e., low conversion) and low molecular weight (non-reactive) (co)polymer in the ungelled (sol) portion which may further contribute to pop-off failure and light residue on the substrate surface (i.e. ghosting). In addition, the overall residence time to complete the polymerization, without resorting to greatly excessive dose and more highly cross-linked (co)polymer, is significant. For this reason the process of making a pressure sensitive adhesive, for example, with a conventional, curtain-style, continuous e-beam is considered to be slow.

### Pulsed Electron-Beam Polymerization

In an earlier patent application, a method of polymerizing monomers and/or oligomers to make pressure sensitive adhesives using a pulsed beam of accelerated electrons was disclosed. See U.S. patent application Ser. No. 09/853,217, which is incorporated herein by reference.

However, the present inventors recognized the need for an even more efficient polymerization method that is faster in effecting the high-conversion radiation polymerization of (co)polymer precursors coated on a continuous web substrate, and thus which is effective for producing coatings of highly gelled polymers of adequate chain lengths between cross-links over a broad range of coating thickness and with very little low molecular weight material present.

### Scanned, Electron-Beam Polymerization

In order to overcome at least some of the foregoing deficiencies with electron-beam polymerization processes, the present disclosure broadly describes a polymerization process (i.e. method) comprising:
a) coating at least a portion of at least one major surface of a substrate with a polymerizable composition to obtain a coated surface;
b) initiating polymerization of the polymerizable composition by scanning a first electron-beam focused on the coated surface across at least a portion of the coated surface, thereby irradiating the coated surface at a frequency selected to achieve an exposure duration of greater than 0 and no greater than 10 microseconds, and a dark time between each exposure duration of at least one millisecond, thereby producing an at least partially polymerized composition.

In some exemplary embodiments, the method further comprises further irradiating the coated surface with a continuous beam of accelerated electrons from a continuous electron-beam source to further polymerize the at least partially polymerized composition. Optionally, at least one of irradiating the coated surface and further irradiating the coated surface occurs at a temperature below 20° C.

The scanned, pulsed e-beam polymerization process of the present disclosure exposes a polymerizable composition on a major surface of a substrate to irradiation from a scanned electron-beam. Scanning the electron-beam produces very short exposure durations with high peak power, followed by long dark times, resulting in beam current per exposure area that cannot be achieved simply by rapidly switching a conventional non-scanned e-beam on and off.

### Scanned, Pulsed Electron-Beam Polymerization Processes

Various exemplary embodiments of the disclosure will now be described with particular reference to the Drawings. Exemplary embodiments of the invention may take on various modifications and alterations without departing from the spirit and scope of the disclosure. Accordingly, it is to be understood that the embodiments of the invention are not to be limited to the following described exemplary embodiments, but is to be controlled by the limitations set forth in the claims and any equivalents thereof.

In certain exemplary embodiments, the substrate is a web moving in a down-web direction and having a width in a cross-web direction substantially orthogonal to the down-web direction, further wherein scanning the first electron-beam across at least a portion of the coated surface comprises scanning the electron-beam in the cross-web direction, scanning the electron-beam in the down-web direction, and combinations thereof.

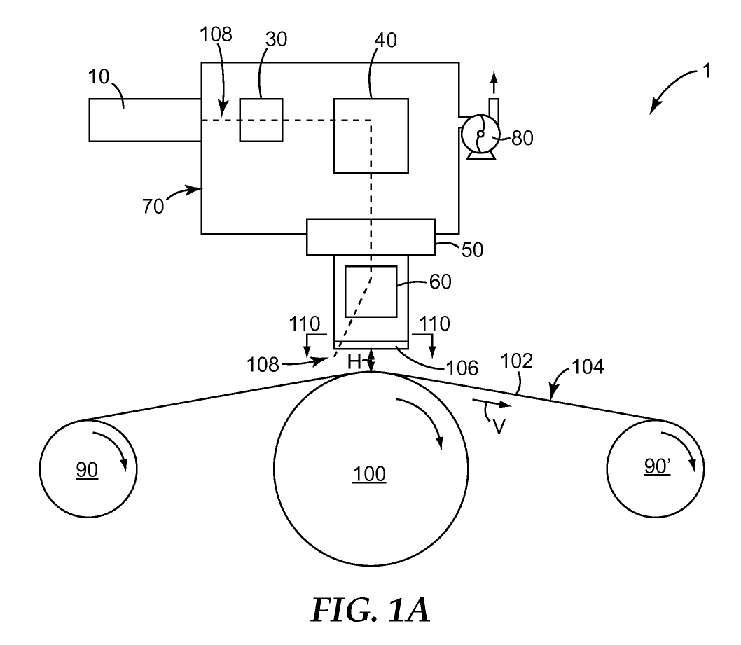

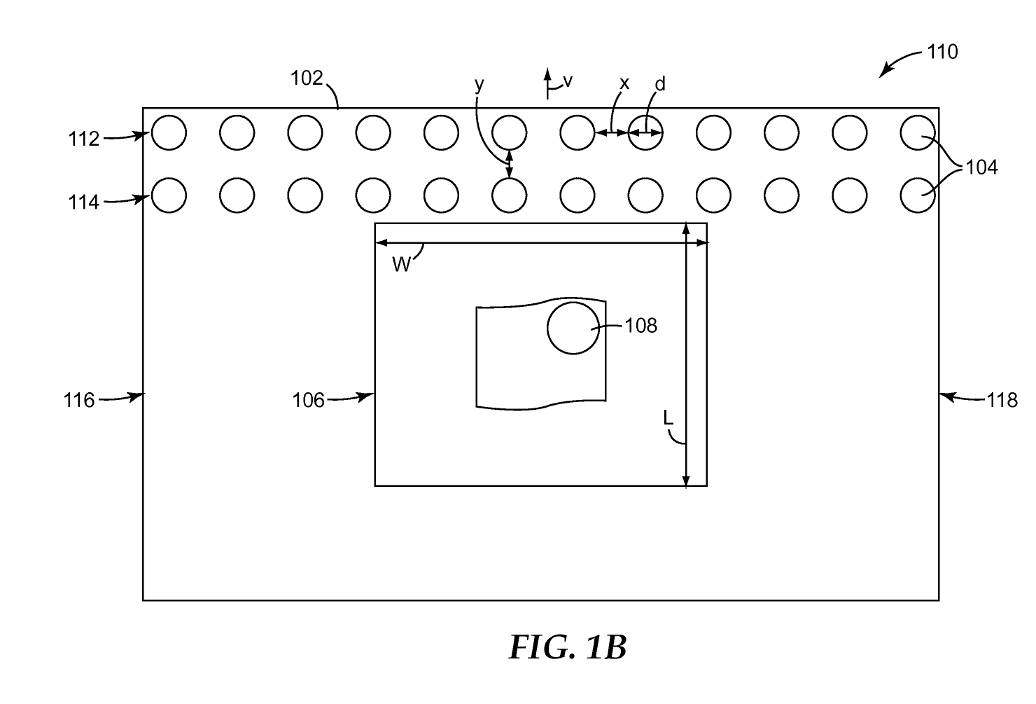

FIG. 1A is a side view of an exemplary apparatus 1 useful in practicing various exemplary embodiments of the present disclosure in which the substrate is a moving web. The apparatus includes an electron-beam source 10 (which may be either a continuous emission electron-beam source, or a pulsed emission electron-beam source as described above). The electron-beam source 10 is configured to emit an electron-beam 108 into a vacuum chamber 70. A vacuum pump 80 maintains the vacuum chamber 70 under suitable low pressure conditions as is well known in the art.

In the illustrated exemplary embodiment of FIG. 1A, the emitted electron-beam 108 passes through a quadrupole 30 and an optional bend magnet 40 may be used to change the direction of the electron-beam 108. Although the use of an optional bend magnet 40 is illustrated in FIG. 1B, it will be understood that it may be advantageous to eliminate the optional bend magnet 40, provided that the substrate 102 to be exposed to the e-beam 108 can be positioned to intercept the electron-beam directly emitted from the electron-beam source 10.

The electron-beam 108 passes through an small opening or aperture in lead shielding 50 into a scanner 60, which is capable of scanning the electron-beam in at least one, and preferably two dimensions. The scanned e-beam 108 passes through an e-beam transmissive window 106, and impinges on polymerizable composition 104 on a major surface of substrate 102, which is shown in FIG. 1A as a web extending from unwind transport roller 90 to wind-up transport roller 90′. Rotation of the transport rollers 90-90′ moves the substrate 102 in the machine or down-web direction at velocity v_{w}.

In the illustrated exemplary embodiment, a back-up roller 100 is positioned to maintain a gap H between the electron-beam transmissive window and the polymerizable composition 104 on the major surface of substrate 102. Although a back-up roller 100 is shown in FIG. 1A, it is to be understood that another structure (e.g. a flat platen, a vacuum platen, a moving belt, a vacuum belt, and the like) may be advantageously substituted for back-up roller 100 to maintain gap Hv, and/or to capture electrons and/or cooling the substrate 102. Alternatively, a back-up roller 100 or other structure need not be used to maintain the gap H (e.g. a free span of the substrate may be used).

Preferably, gap H is maintained at greater than 0 to less than about 25 mm, more preferably from 5 to about 22 mm, even more preferably from about 10 to about 20 mm; more preferably still from about 15 to about 19 mm. Preferably, back-up roller 100 has a larger diameter than transport rollers 90-90′.

Preferably, back-up roller 100 has a diameter of at least 10 cm, at least 25 cm, at least 50 cm, or even as much as 80 cm, 90 cm or even 100 cm, in order to create a more planar exposure region for substrate 102 as it passes under the e-beam transparent window 106 and is scanned by e-beam 108. In some embodiments, it may be preferable that back-up roller 100 has a perforated surface through which a partial vacuum is drawn to assist in holding the substrate 102 flat as it passes over back-up roller 100 and under the e-beam transparent window 106 and is scanned by the e-beam 108.

Thus, in the illustrated exemplary embodiment of FIG. 1A, the substrate 102 is a web moving in the down-web direction corresponding to the velocity vector v_{w}, and having a width in a cross-web direction substantially orthogonal to the down-web direction. The scanned e-beam may, in some exemplary embodiments, be scanned across the polymerizable composition 104 on a major surface of substrate 102 in the cross-web direction, the down-web direction, or a combination thereof.

In further exemplary embodiments not shown in the drawings, the method may further comprise further irradiating the at least partially polymerized polymerizable composition with a continuous beam of accelerated electrons from a continuous electron-beam source to further polymerize the at least partially polymerized composition.

Process Using a Pulsed E-Beam Source

In some particular exemplary embodiments, the first electron-beam is a pulsed electron-beam. Thus, in one exemplary embodiment, a pulsed e-beam is focused on a polymerizable composition coated on a major surface of a substrate and scanned across the surface, thereby irradiating the coated surface at a frequency selected to achieve an exposure duration of greater than 0 and no greater than 10 microseconds, thereby producing an at least partially polymerized composition.

One advantage of scanned, pulsed e-beams is that they do not suffer from the same voltage limitations of regular, linear-filament beams. It is therefore possible to readily scale-up scanned, pulsed e-beam polymerization processes to make use of high powered (i.e. MeV) e-beams, which allow for single-pass irradiation of even very thick (e.g. two or more centimeter thick) substrates.

FIG. 1B shows top view 110 as shown in FIG. 1A, looking through the e-beam transmissive window 106 having length L and width W. FIG. 1B illustrates a scanned, pulsed first electron-beam 108. Although a pulsed emission electron-beam source is shown for illustrative purposes, it will be understood that a continuous emission e-beam source may be used and similarly scanned. In one exemplary embodiment, the e-beam transmissive window 106 is a cooled copper plate that holds a thin metal foil (typically titanium foil of about 0.5 mil or 12.5 micrometers thickness) designed to allow electrons to pass without absorbing too much energy.

The substrate 102 is shown as a web moving at velocity v_{w} in the down-web (machine) direction corresponding to the direction of the velocity vector v_{w}. The substrate 102 has an e-beam exposure zone having a width extending between first lateral edge 116 and second lateral edge 118 in a cross-web direction substantially orthogonal to the down-web direction.

In some exemplary embodiments of any of the foregoing, scanning the first electron beam across the coated surface produces a plurality of irradiated regions of the polymerizable composition, optionally wherein each of the plurality of irradiated regions is surrounded by a non-irradiated region of the polymerizable composition. Thus, in the illustrated exemplary embodiment, scanning the first electron beam 108 across the coated surface produces a plurality of irradiated regions 104 of the polymerizable composition on the major surface of substrate 102. Each irradiated region has a diameter d, which is generally larger than the diameter of the electron beam in the vacuum chamber due to scattering of the e-beam 108 by the window 106 and atmosphere above the sample.

Each irradiated region 104 is separated from a neighboring irradiated region in the downweb or machine direction by a distance y. Each irradiated region 104 is separated from a neighboring irradiated region in the crossweb direction by a distance x. Optionally, as shown in FIG. 1B, each of the plurality of irradiated regions 104 is surrounded by a non-irradiated region of the polymerizable composition. This may facilitate the formation of structures or features formed by the at least partially polymerized polymerizable composition on the major surface of the substrate. In some exemplary embodiments, the plurality of irradiated regions 104 may form one or more rows in the down-web (machine) or cross-web direction, or both, as shown in FIG. 1B. In some exemplary embodiments, the plurality of irradiated regions 104 may form a two-dimensional array pattern in the down-web (machine) and cross-web directions, as shown in FIG. 1B.

In further exemplary embodiments, the non-irradiated region of the polymerizable composition may be removed (e.g. by washing with a solvent which dissolves and removes the unpolymerized polymerizable composition but not the at least partially polymerized composition; by heat treatment to evaporate the unpolymerized polymerizable composition; and the like).

In further exemplary embodiments of the foregoing, a pulse rate of the first electron beam is from about 25 to about 6,000 pulses per second. An intermediate or higher pulse rate is presently preferred. In some exemplary presently preferred embodiments, the pulse rate of the first electron beam is about 100 to about 5,000 pulses per second; about 500 to about 4,000 pulses per second; or about 1,000 to about 3,000 pulses per second.

In some exemplary embodiments, the exposure duration is from greater than zero (e.g. about 0.5 microseconds or even as low as 0.1 microseconds) to about 9 microseconds per pulse. Lower exposure duration is presently preferred. In some presently preferred embodiments, the exposure duration is from about 1 to about 8 microseconds per pulse; from about 2 to about seven microseconds per pulse; from about 3 to about 6 microseconds per pulse; or from about 4 to about 5 microseconds per pulse. In some presently preferred embodiments, irradiating with pulses of accelerated electrons from a pulsed electron beam source comprises irradiating at a pulse duration of from about 0.1 to less than 5 microseconds per pulse, 0.2 to less than 2 micro-seconds per pulse; or even 0.25 to 1 microsecond per pulse.

In certain exemplary embodiments, the first electron beam delivers an electron beam dose per exposure duration between 0 and 10 Gy. Lower electron beam dose per pulse is presently preferred. In some presently preferred embodiments, the first electron beam delivers an electron beam dose per exposure duration of between 0 and 2.5 Gy; from about 0.5 to about 2 Gy; from about 0.75 to about 1.5 Gy; or even 1 Gy.

In some exemplary embodiments of any of the foregoing, scanning the first electron beam across the coated surface produces a plurality of irradiated regions of the polymerizable composition, optionally wherein each of the plurality of irradiated regions is surrounded by a non-irradiated region of the polymerizable composition.

### Process Using a Continuous E-Beam Source

In other exemplary embodiments, the first electron beam is a continuous electron beam. Thus, in another exemplary embodiment, a continuous e-beam is rapidly scanned across a polymerizable composition coated on a major surface of a substrate, thereby irradiating the coated surface at a frequency selected to achieve an exposure duration of greater than 0 and no greater than 10 microseconds, and a dark time between each exposure duration of at least one millisecond, thereby producing an at least partially polymerized composition. Observed from a fixed location on the web under the e-beam, rapidly and repeatedly scanning a continuous e-beam focused on a portion of a surface simulates use of a pulsed e-beam source. A brief exposure of a discrete portion of the polymerizable composition coated on a major surface of a substrate is followed by dark time while the scanned beam traverses the rest of the scanned area of the coated surface.

Such a focused continuous e-beam exposure overcomes, in some exemplary embodiments, the limitations associated with too low an e-beam dose per pulse, the beam power per unit area increases as the exposed beam area shrinks By rapidly scanning the continuous focused e-beam over the intended exposure area of the substrate, thereby effectively raising the power-to-area ratio, the desired polymerization rates can be achieved, without excessive average power consumption.

There are two important aspects which facilitate implementation of a scanned, pulsed electron beam polymerization process using a continuous emission electron beam source. First, the total scan zone (the surface area of the substrate actually scanned in the process) is larger than the window opening. Second, the electron beam diameter inside the vacuum chamber is significantly less than the beam diameter at the surface of the substrate, due to scattering of the beam by the window and atmosphere above the sample.

The following parameters may be defined for a scanned, pulsed electron beam polymerization process implemented using a continuous emission e-beam source:

X: total cross-web scan width

Y: total down-web scan width

d: spot size (diameter of electron beam) inside vacuum chamber

vₓ: velocity of spot in cross-web direction

v_{y}: velocity of spot in down-web direction

W: total cross-web width of window opening

L: total down-web width of window opening

D: spot size (diameter of electron beam) at sample/web surface

v_{w}: velocity of moving web

The following parameters describe the simulated pulsing of a scanned continuous e-beam:

fₓ: scan frequency in the cross-web direction (note that fₓ=vₓ/X)

f_{y}: scan frequency in the down-web direction (note that f_{y}=v_{y}/Y)

I: electron beam current

V: electron beam voltage

From the above, we can determine the pulse width, i.e. the length of on-time during a single pulse:

Pulse width(on-time): tₒₙ=D/vₓ=D/(fₓX)

The velocity of the e-beam spot focused on the surface of the coated polymerizable composition on a major surface of the substrate in the down-web direction, v_{y}, determines the overall frequency of pulsing, as experienced on the web, or the dark time between pulses. Thus, if v_{y} is zero, i.e. a single line is scanned back and forth across the web, the overall scan frequency is simply fₓ and the dark time is:

t_{off}=(X−D)/fₓ, or t_{off}=X/fₓ assuming X>>D.

If v_{y} is large enough to avoid overlap between successive cross-web scan lines, the dark time is:

t_{off}−1/f_{y}

Thus, the main pulsing frequency is set by the frequency of the down-web scan, f_{y}, and the pulse width is set by the cross-web scan frequency, fₓ.

An intermediate case exists in which v_{y} is non-zero but small enough to lead to overlap between successive scan lines. This can complicate the pulsing description from the web perspective, but it should be noted that there is an optimal frequency f_{y} that leads to a uniformly irradiated area. Since the dose distribution in a beam spot is not uniform by roughly follows a normal distribution, a uniform irradiation would result from a scanned exposure in which each successive cross-web scan line is offset from the previous by a distance of D/2.

This would result in just enough overlap between scan lines to offset the current drop-off around the edges of the beam spot. Thus, in a time t_{off}=(X−D)/fₓ, the down-web scanner should move the line a distance of D/2, so that v_{y}=D/2t_{off}=(Dfₓ)/(2(X−D))=(Dfₓ)/(2X), assuming again X>>D. Since v_{y}=f_{y}Y=(Dfₓ)/(2(X−D)), or:

f_{y}/fₓ=(DY)/(2(X−D))=(DY)/(2X)

Thus, the optimal frequency ratio is proportional to the beam spot size and the ratio T of down-web to cross-web scan distances.

In some exemplary embodiments, the exposure duration is from greater than zero (e.g. about 0.5 microseconds or even as low as 0.1 microseconds) to about 9 microseconds. Lower exposure duration is presently preferred. In some presently preferred embodiments, the exposure duration is from about 1 to about 8 microseconds; from about 2 to about seven microseconds; from about 3 to about 6 microseconds; or from about 4 to about 5 microseconds.

In certain exemplary embodiments, the first electron beam delivers an electron beam dose per exposure duration between 0 and 10 Gy. Lower electron beam dose per pulse is presently preferred. In some presently preferred embodiments, the first electron beam delivers an electron beam dose per exposure duration of between 0 and 2.5 Gy; from about 0.5 to about 2 Gy; from about 0.75 to about 1.5 Gy; or even 1 Gy.

Processes Using Variable Down-Web Scanning

The parameters listed above will lead to down-web scanning frequencies on the order of cross-web frequencies. This means that the dark times resulting from scanning that optimizes coverage will be much too short to allow for long dark times that are key to making PULSED E-BEAM outperform continuous e-beam (rapidly initiated free radicals need to be given time to react by propagation before termination reactions set in that deplete the overall population of free radicals). In practice, for a typical PULSED E-BEAM irradiation, a frequency on the order of 1 kHz represents a good compromise between rapid and lean processing. As described below, cross-web scanning frequencies are typically on the order of 10-100 kHz, so the down-web scanning frequency has to be reduced. While the beam is in the irradiation zone, uniform coverage is important, so the speed v_{y} in that zone should generally not be reduced.

One simple way to reduce f_{y} without affecting v_{y} is to “park” the beam up- and down-stream of the beam window during exposures. That is, the beam can scan rapidly across the beam window to give the uniform coverage and kinetics required by the process, but then it can dwell on the beam stop positioned on either side of the beam window to pass the time before a new pulse should be initiated. During this time (on the order of 1 ms) the reactions that were initiated during the scan across the window can proceed until most reactivity is lost and a new scan across the window is initiated.

When such a down-web scan strategy is employed, the relationship f_{y}=v_{y}/Y no longer holds as f_{y} and v_{y} are effectively decoupled to meet the desired pulse kinetics. The pulse width, i.e. the length of on-time during a pulse, is a useful scanned, pulsed e-beam polymerization process variable that affects the efficiency of pulsing greatly. With each pulse the free radical concentration goes up initially, nearly instantaneously. The free radicals are being produced by ionization of some monomers, which is what leads to free radical initiation of polymerization with other monomers to form polymers.

This gives rise to an increase in propagating free radicals. The free radical concentration, however, drops as diffusion takes place and termination becomes dominant, until the syrup or polymerizable composition is irradiated with another pulse of an e-beam. The concentration of the monomer decreases steadily with each pulse as monomer is being consumed by polymerization and conversion increases.

In exemplary embodiments of the scanned, pulsed e-beam polymerization process of the present disclosure, and under selective conditions, the pulses of electrons produce free radicals in the polymerizable material on the surface of the substrate that are spatially isolated from one another. This allows more time for the free radicals to react with monomer and grow longer (co)polymer chains before encountering another free radical and terminating. Because this chemistry is controlled by diffusion of reacting species, the isolation of free radicals is also assisted or improved by lowering the temperature (or otherwise raising the viscosity) of the polymerizable composition while it is being irradiated with pulses of electrons.

The initial ionizing events of the scanned, pulsed e-beam polymerization process of the present disclosure occur during the deposition of energy by accelerated electrons and are heterogeneous in nature. They are described by a track-and-spur structure where ionization events from single accelerated electrons are distributed at some distance from one another, either as isolated or clustered sites. The energy deposited per spur (50-100 eV) is sufficient to result in formation of several free radicals. Free radicals emerge from each track as the surviving species of the early events. Because the tracks are separated by a sufficient distance (due to low dose per pulse) there is a short time period when the free radicals can propagate with minimum contact with one another. Eventually, diffusion causes the system to become homogeneously distributed and the rate of termination then increases significantly. A low dose per pulse maintains spatial distance between the electron tracks to allow chain propagation to proceed with a minimum of chain terminations resulting from combination with free radicals formed by a different neighboring track.

Because free radical polymerization is very fast (rate constants are on the order of 10⁴ to 10⁵ l/mol-s), it is possible to introduce successive pulses of radiation at very high rates (several kHz) and still maintain heterogeneous kinetics. As long as the dose per pulse is below the threshold where significant spatial overlap of the track-and-spur structures occurs, it is possible to take advantage of heterogeneous (localized) kinetics. It is primarily the large separation between tracks at low dose per pulse that is responsible for maintaining localized kinetics. For as long as this advantage can be maintained, an increase in dose rate (pulse rate) will simply add more radicals while the total dose required for achieving high conversion will not change significantly. The rate of polymerization will be proportional to the rate of initiation (Ri) rather than the rate of termination (Ri^{1/2}).

In some exemplary embodiment of the scanned, pulsed e-beam polymerization process of the present disclosure, the best results occur when a low dose per pulse is used with a high pulse rate. This seems to give the best free radical isolation. A high steady state concentration of propagating radicals at high pulse rate can be maintained when spatial separation of initiating radicals is sufficiently high (low dose per pulse). Without wishing to be bound to any particular theory, it is presently believed to be important to control the overlap in space to minimize termination and to shorten the time interval between pulses to gain efficiency. An interval of even as small as a half of a millisecond is still sufficiently long enough for free radical decay (lifetime), so as not to introduce excessive termination. Increased termination may result from temporal overlap of electron tracks. At some point, higher frequencies will overlap temporally to a sufficiently greater degree, thereby losing efficiency and converging with the kinetics of continuous polymerization.

### Scanned, Pulsed E-Beam Process Parameters

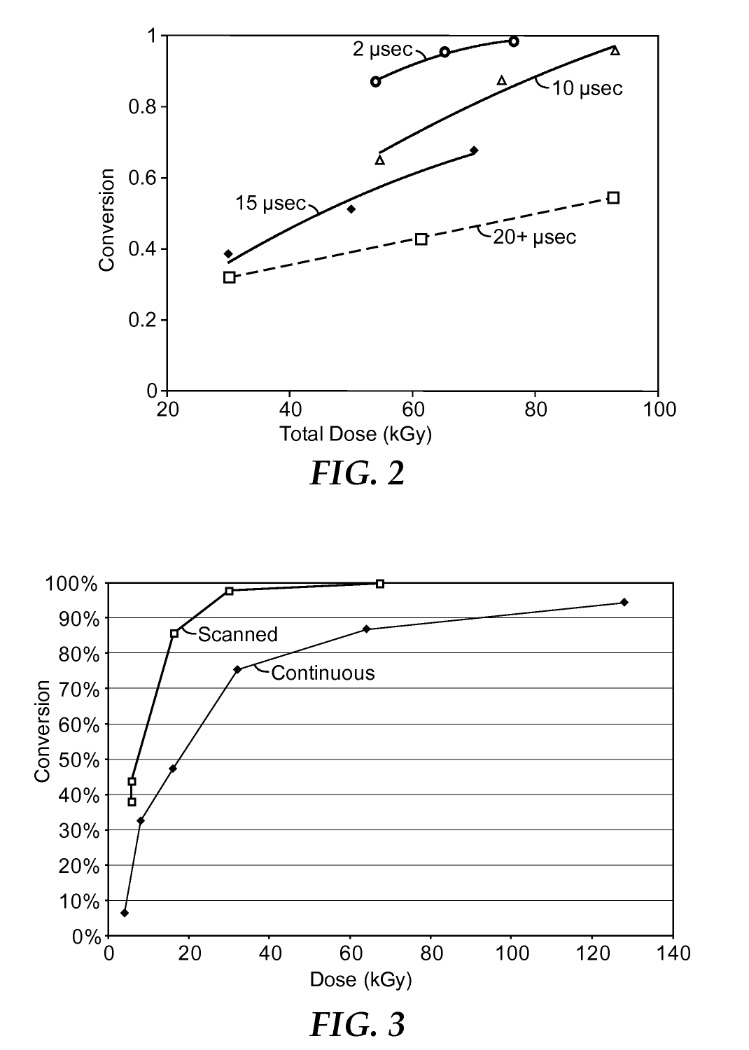

FIG. 2 is a graph of the monomer fractional conversion as a function of the total electron beam dose obtained in exemplary embodiments of scanned pulsed electron beam polymerization using four different pulse rates. FIG. 2 illustrates a substantial increase in fractional conversion of the initial monomer (conversion efficiency is 100% times the fractional conversion) as the exposure duration is decreased, with conversion efficiency exceeding 90% for exposure durations of 10 microseconds or less for total dose of at least about 80 Gy; conversion efficiency exceeding 90% for exposure durations of 2 microseconds or less for total dose of at least about 65 Gy; and conversion efficiency exceeding 95% for exposure durations of 2 microseconds or less for total dose of at least about 70 Gy.

Residence Time

In a free radical polymerization, the rate of initiation determines the concentration of radicals. The rate of termination is generally proportional to the concentration of radicals, with a comparatively large number of terminations at high radical concentrations. This results in lower molecular weight and highly cross-linked gel. In the present disclosure, the rate of initiation resulting from electron beam has been controlled, so as to achieve high molecular weight between cross-links and high conversion by decreasing the flux of electrons (current) and increasing the residence time under the beam to accumulate the desired dose. Residence time has been increased by lowering the speed of transit under the beam or increasing the area of irradiance under the beam.

The residence time using pulsed e-beam is less than that required when using a continuous e-beam. In order to achieve high conversion of monomer to (co)polymer (i.e., greater than about 90%) using pulses of accelerated electrons at the dose levels specified herein, a residence time of about 1.5 to 5 seconds would generally be required.

A number of different methods can be employed to provide the desired total dose and residence time for polymerization. One method employs a shuttle system communicating with an on-off switch for the electron beam generator that causes the substrate with the coating of polymerizable composition to remain stationary under the e-beam window until the desired total dose of electron beam energy has been deposited. A second method employs a continuously moving conveyor belt to move the coated substrate under the e-beam window at a speed calculated to deposit the desired total dose of electron beam energy onto the polymerizable composition. A third method moves a continuous web of the polymerizable composition past an array of electron beam generators operated and positioned to provide the desired total dose of electron beam energy across an extended surface area of the web.

Dose

Dose is the total amount of energy deposited per unit mass. Dose is commonly expressed in kilograys (kGy). A kilogray is defined as the amount of radiation required to supply 1 joule of energy per gram of mass.

The total dose received by a polymerizable composition primarily affects the extent to which monomer is converted to (co)polymer and the extent to which the polymers are cross-linked. In general, it is desirable to convert at least 95 wt %, preferably 99.5 wt %, of the monomers and/or oligomers to (co)polymer. However, the conversion of monomers to (co)polymer in a solventless or low solvent system is asymptotic as the reaction progresses due to diffusion limitations inherent in such systems. As monomer concentration is depleted it becomes increasingly difficult to further polymerize the diffusion-limited monomers.

Dose is dependent upon a number of processing parameters, including voltage, speed and beam current. Dose can be conveniently regulated by controlling line speed (i.e., the speed with which the polymerizable composition passes under the e-beam window), the current supplied to the extractor grid, and the rate of the pulses of accelerated electrons. A target dose (e.g., 20 kGy) can be conveniently calculated by the KI=DS equation, where K is the machine constant, I is current (mA), D is dose in kilograys, and S is speed, in fpm or cm/sec. The machine constant varies as a function of beam voltage and cathode width.

Generally, the dose required for full conversion is proportional to the dose rate. At sufficiently low dose rates, a dose of 20 kGy will be sufficient but residence time may be too long to be practically maintained using e-beam. On the other hand, as dose rate is increased an excessively high dose will be required to overcome the higher rate of termination. For a conventional (continuous) e-beam, a dose on the order of 150-200 kGy may be required to achieve high conversion in a residence time on the order of 2 seconds. This will require a large power supply and may generate excessive heat. Furthermore, desired physical properties of the articles made by the present disclosure may be limited by the excessive cross-linking and grafting reactions as well as low molecular weight material that result from using a high dose.

In this disclosure, however, in which pulses of accelerated electrons are employed rather than a continuous beam, high conversion results at about the same total dose level as required for a continuous electron source, but in less time. For example, only about 2 seconds of residence time is required for pulsed e-beam, as opposed to about 5 seconds for continuous at a dose of 80 kGy.

Dose rate is calculated from the dose delivered to the sample (kGy) divided by the duration of the exposure to radiation in seconds (residence time). Residence time governs the dose required, which in turn determines the dose rate. The preferred dose per pulse is low. An optimum dose per pulse is about 10-30 Grays. At low dose per pulse, the excessive termination of propagating free radicals due to spatial overlap of e-beam produced tracks is avoided.

Pulse Characteristics

### Pulse Rate

The preferred pulse rate for pulsed e-beam polymerization is a high rate. An optimum practical pulse rate is about 1000-2000 pulses per second (“pps”) or Hertz (“Hz”). A higher rate may, however, provide further benefit. The upper limit to the desired pulse rate is when the efficiency is reduced by sufficient temporal overlap of tracks so as to limit the time necessary to complete the heterogeneous phase of the polymerization. Up to that point, increasing pulse rate also increases efficiency.

### Pulse Interval

Pulse interval is on the order of 1 millisecond between pulses. The kinetic rate constant is of sufficient magnitude to reflect rates of conversion significantly faster than a millisecond in time. (Kₚ=10⁴ to 10⁵ l/mol-s).

### Pulse Width (or Duration)

Pulse width (a.k.a. pulse duration) is the full width at half maximum of the e-beam current as a function of time.

Pulse widths of up to 250 microseconds may be possible before they become sufficiently long enough in duration to begin to approach the equivalence of a continuous beam. The polymerization efficiency will decrease at this point and there will be no more advantage to widening the pulse width.

The pulse width or duration may be wide in the present disclosure. This provides a distinct advantage to the method.

If necessary, to achieve pulse durations on the order of 1 to 2 microseconds, it is necessary to use a high speed switch, such as a thyratron, in the pulse forming network. These devices are quite expensive. High speed switches are not, however, necessary for the present disclosure. Since wider pulse widths can be used effectively, conventional solid-state switches may be used. For example, in the present disclosure, a 25 microsecond pulse width may be used, which would allow the dose to be spread out sufficiently so as to reduce the thermal shock waves on the beam window. The pulse width is still, however, very small ( 1/20^{th}) compared to a pulse interval as short as 0.5 milliseconds.

Dynamic Pulsing

The foregoing disclosure describes scanned, pulsed e-beam polymerization processes in which the e-beam is uniformly scanned in both the cross-web and the down-web direction, with the beam “parked” on either side of the beam window in the down-web direction to achieve the necessary time interval between pulses.

Scans do not need to be uniform in this way. The benefits of Pulsed electron beam irradiation over continuous e-beam irradiation diminish after about 50% conversion is reached. This can be explained by the reduced mobility of all species in the polymerizing material. Once mobility is low, termination reactions are less likely to occur than early in the process when monomers move about quickly. To achieve high conversion, more and more e-beam energy is needed, and it is the overall amount of dose delivered that is more important than how it is delivered.

This sets the stage for “dynamic pulsing,” which could vary the down-web beam position almost arbitrarily. It would thus be possible to slow down the down-web scan from a rapid scan at the entrance side of the web (early in the reaction) to a very slow scan at the exit side, where lean pulsing is no longer required, but high dose rates are desirable. Such an electronically controlled change in dose rate and pulsing characteristics could also be used to respond in real time to external inputs that might, for example, be based on changes in coat weight of the incoming web. Dynamic pulsing can be implemented on the apparatus in FIG. 1A, subject to the limitation that the overall down-web position of the beam spot integrate to zero over time,

$$i . e . {\int }_{0}^{∞} y d y = 0.$$

### Other Process Characteristics

Inert Atmosphere

E-beam irradiation of the polymerizable composition is preferably carried out in the presence of minimal amounts of oxygen, which is known to inhibit free-radical polymerization. Hence, e-beam irradiation of the polymerizable composition should be conducted in an inert atmosphere such as nitrogen, carbon dioxide, helium, argon, etc. Polymerization is preferably conducted, for example, in a nitrogen atmosphere containing up to about 3,000 parts per million (ppm) oxygen, preferably limited to 1,000 ppm oxygen, and more preferably 50 to 300 ppm oxygen, to obtain the most desirable adhesive properties. The concentration of oxygen can conveniently be measured by an oxygen analyzer.

Oxygen can be substantially excluded in making an adhesive, for example, by sandwiching the adhesive syrup between solid sheets of material (e.g., a tape backing and a release liner) and irradiating the adhesive syrup through the sheet material.

Temperature

Another aspect of the disclosure involves curing/polymerizing at low temperatures. Superior adhesive properties and high conversion were achieved for pressure sensitive adhesives by cooling the adhesive syrup for a pressure-sensitive adhesive to a temperature below 20° C., preferably below 10° C. and most preferably below 5° C. The temperature was preferably maintained between about −80° C. to 10° C. and most preferably between about 0 to 5° C. See U.S. patent application Ser. No. 09/118,392, which is incorporated herein by reference. It is believed that by conducting polymerization using a continuous beam of accelerated electrons at temperatures below 20° C., the rate of (co)polymer chain propagation is increasingly favored over the rate of termination, with the effect of producing polymers with a higher gel content and higher conversion.

When using the pulses of accelerated electrons, similar advantages were found at low temperatures because it allows the use of instantaneously high dose rates per pulse. Low temperature increases the viscosity of the system. When the viscosity is increased, the diffusion of free radicals is slowed. This helps to isolate the free radicals, reduce termination, and allow for more polymerization. Therefore, the temperature is preferably maintained at a low temperature during the present inventive process to make pressure sensitive adhesive articles. However, it is not necessary, but may be beneficial, to maintain the low temperature for the production of other articles (i.e. coatings) using the inventive process. In the alternative, for articles other than pressure sensitive adhesives, it may be beneficial to keep the temperature low for about the first 40-80%, and preferably 50-70%, of the reaction time. It is also known that higher levels of cross-linker (1%) may be used to off-set the need for low temperatures by speeding up the rate of conversion. However, if higher levels of cross-linker are used to make a pressure-sensitive adhesive article, the adhesive physical properties may be limited.

The term “low temperature” refers to any temperature below ambient, which can be consistently maintained, and which is below about 20° C. However, there are increasing advantages with lower temperatures down to −70° C. (i.e. using dry ice).

The temperature of the polymerizable composition can be maintained at the desired low temperature during polymerization, or a portion of the polymerization time, by a variety of techniques, such as introducing chilled nitrogen gas into the radiation chamber, placing the coated polymerizable composition upon a cooling plate, or use of any other type of heat sink or chilled drum.

Conditions that are optimum for pulsed polymerizations appear to be more dependent on temperature control than for continuous, possibly due to the higher instantaneous dose rate of a single pulse and the need to limit diffusion to prolong the heterogeneous mode. Thus, in any of the foregoing embodiments, irradiating with pulses of accelerated electrons from a pulsed electron beam occurs at a temperature below 20° C.

Using a scanned, pulsed electron beam polymerization process results in clear benefits over continuous radiation polymerization, as polymerization of monomers without excessive and premature cross-linking becomes feasible at reasonable process speeds. Additionally, use of scanned, pulsed e-beam polymerization generally improves (co)polymer chain grafting and cross-linking, thereby strengthening the (co)polymer sufficient for use as a hardcoat.

Exemplary embodiments of the present disclosure have advantages over use of other types of irradiation (e.g. gamma radiation, ultraviolet radiation, and the like), as well as a continuous e-beam or a non-scanned pulsed e-beam. One such advantage of exemplary embodiments of the present disclosure is that the polymerization process is effective for quickly and efficiently producing polymers having a sufficient cross-link density. One use for such a cross-linked polymers is in a pressure-sensitive adhesive composition requiring superior peel adhesion and superior shear strength and high conversion, which does not require the use of solvents or chemical initiators for the conversion process to take place.

A second advantage of at least one exemplary embodiment of the present disclosure is that the deposition of energy by the pulses of accelerated electrons, under certain conditions (e.g. low dose/pulse and high pulse rate), is heterogeneous in nature. Thus, in any of the foregoing exemplary embodiments, the polymerizable composition may be polymerized heterogeneously in a single phase. Heterogeneous polymerization (polymerization in heterogeneous mode or fashion) occurs when free radicals are localized (non-random) by any of several mechanisms involving different states of matter or phase separation within a given state of matter in order to restrict their diffusion. This has the effect of limiting termination reactions. In homogeneous polymerization, the diffusion of monomer to the free radicals is not restricted. Termination results from a propagating free radical being joined by another free radical, rather than a monomer, to effectively end propagation. The two unpaired electrons combine to form a single bond.

The ionization events, in heterogeneous polymerization, are distributed at some distance from one another as isolated sites where free radicals emerge as surviving species before diffusion causes the system to become homogeneously distributed. This effectively allows polymerization to take place and reduces termination because the free radicals are separated from each other spatially for a short time period. The reduction in termination results in higher conversion values for the polymerization method.

Homogeneous polymerization (or polymerization in a homogeneous fashion or mode), on the other hand, is polymerization in which the free radicals are distributed randomly in a single-phase medium and are free to diffuse. The termination that results is governed by the thermodynamics of movement (which is continuous zigzag motion of the molecules caused by impact with other molecules of the liquid). Termination effectively occurs more easily and quickly than in heterogeneous polymerization.

Another advantage of at least one embodiment of the present disclosure is that the residence time needed to produce an article using the method is shorter, because of reduced terminations, than using the other methods of irradiation or a continuous beam of electrons. This means that more practical throughput rates can be achieved. The reduced residence time results, in part, from the increased conversion efficiency of the monomers, comonomers and oligomers in the polymerizable composition, In some exemplary presently preferred embodiments, the conversion efficiency of the polymerizable composition is greater than 90%, more preferably greater than 92%, even more preferably greater than 95%, more preferably still greater than 98% or even 99%. Optionally, the gel percent is greater than 95%, more preferably greater than 96%, 97%, 98%, or even 99%.

A further advantage of at least one embodiment of the present disclosure is that pulsing the electron beam decreases the high voltage hold-off (i.e. using more robust insulation around the cathode and high voltage components) required by continuous e-beams to prevent internal arching. Therefore, there may be the opportunity to lower capital cost to build equipment by using less expensive components and more compact vessels.

An additional advantage, in some exemplary embodiments, is the tolerance for longer or wider pulse duration or pulse width than is typical of thyratron types of pulse forming equipment (1-2 microseconds). The tolerance of pulse durations of about 1-250 microseconds allows latitude in the choice of pulse-forming networks which include less expensive, more conventional capacitor-discharge types. Also, there is less thermal shock experienced by the beam window at the wider pulse-width.

Another advantage in at least one exemplary embodiment over the UV-based process is that a clean and clear adhesive can be made without the photoinitiators or triazine residues. Also, highly pigmented adhesives can be produced that would not be able to be produced by UV because they are opaque to UV light.

Yet another advantage of at least one embodiment of the present disclosure is that it allows for polymerization of materials with short stability times, because the process is so fast. For instance, polymerization of a mixture of two immiscible materials is possible. The mixture can be polymerized after it has been mixed and before it has a chance to phase separate. In addition, polymerization of thin layers of materials that evaporate quickly after being coated is also possible. Further, because temperature control can be practically maintained throughout the short time period necessary for polymerization, it is possible to polymerize biphase compositions with novel morphology or topology.

An additional advantage of exemplary embodiments of the present disclosure is that there are fewer contaminants than with other processes. In other processes for making a pressure-sensitive adhesive, for example, catalysts or initiators are used to make the adhesive. The initiator, or parts of it, remains in the adhesive that is formed using the initiator. It is important, in the electronics industry, for example, to keep these contaminants to a minimum. When adhesives, for example, are used in or near electronics, any contaminants in the adhesives or out-gas may cause undesirable reactions in the electronics, such as corrosion. The pulsed e-beam process does not use initiators, and, therefore, eliminates this problem.

One more advantage of at least one exemplary embodiment of the present disclosure is that it is versatile. For example, the method may be used to polymerize solventless blends as well as emulsions, which may be coated on-web and then polymerized.

### Materials

Substrates

A wide variety of substrates can be used to make articles using the present disclosure, so long as the substrate is not substantially degraded by electron beam irradiation. Suitable substrates used to make articles using the present disclosure include metal films, such as aluminum foil, copper foil, tin foil, and steel panels; plastic films, such as films of polyvinyl chloride, polyethylene, polypropylene, polyethylene terephthalate, nylon, polyesters, polystyrene, polycarbonates, polyphenylene oxides, polyimides, polyvinyl fluoride, polyvinylidene fluoride and polytetrafluoroethylene; metalized plastics; cellulosics such as paper and wood; and fabrics such as woven and non-woven cotton, nylon and wool and synthetic non-wovens.

A pressure-sensitive adhesive tape, wherein a pressure-sensitive adhesive is formed or coated on a thin, flexible substrate material, or a surgical adhesive dressing, wherein the adhesive is formed on a moisture vapor transmissive backing sheet, may also be formed using this process. The adhesive may also be used as a laminating binder or provided as a supported or unsupported film.

An advantage provided by effecting e-beam curing of an adhesive syrup directly upon the end-use substrate is the ability to use e-beam irradiation to create reactive sites in both the adhesive syrup and the substrate so as to cause chemical bonding between the adhesive and the substrate at the interface of these two layers, thereby grafting the adhesive to the substrate and eliminating the need to prime or otherwise treat the substrate prior to coating.

Suitable substrates used to make coated articles using the present disclosure include such materials as metals, woods, plastics, or composites of different materials. The present disclosure, however, is not limited to the substrates described herein and may include the use of other materials that are also not substantially degraded by electron beam irradiation.

Polymerizable Compositions

In exemplary embodiments, the polymerizable composition comprises at least one polymerizable monomer, at least one oligomer, or a combination thereof. In further such exemplary embodiments, the polymerizable composition further comprises at least one polymerizable comonomer. Additional optional ingredients include comonomers, cross-linking agents, free-radical yielding agents, photoinitiators, additives, thickeners and tackifiers.

(Meth)Acrylate Monomers

All (meth)acrylate monomers are useful in the present disclosure. Alkyl (meth)acrylate monomers particularly useful in this disclosure are those that free-radically polymerize quickly, and with which propagation reactions occur preferentially over termination or cross-linking reactions. Such free-radically polymerizable acrylate monomers particularly useful in the polymerizable composition to form pressure-sensitive adhesives using the present disclosure are those that have a homopolymer glass transition temperature less than about 0° C., and preferably less than about −20° C.

In some exemplary embodiments the at least one polymerizable monomer comprises a C₈₋₁₃ alkyl (meth)acrylate monomer. In certain such exemplary embodiments, the C₈₋₁₃ alkyl (meth)acrylate monomer is selected from the group consisting of isooctyl acrylate, 2-ethylhexyl acrylate, lauryl acrylate and tridecyl acrylate. In some particular exemplary embodiments, the at least one polymerizable monomer is selected from the group consisting of methyl methacrylate, isobornyl acrylate, tripropyleneglycol diacrylate, pentaerythritol triacrylate, pentaeryritol tetraacrylate, hydantoin hexacrylate, and trimethylolpropylenetriacrylate.

Other monomers that may be used to form coatings using the present disclosure, include, but are not limited to, methyl methacrylate, isobornyl acrylate, tripropyleneglycol diacrylate, pentaerythritol tri(and tetra)acrylate, hydantoin hexacrylate, trimethylolpropylenetriacrylate, and multifunctional acrylates in general. These monomers have higher glass transition temperatures than those used for pressure-sensitive adhesives. The glass transition temperatures of such monomers are generally above ambient temperature. Careful control of molecular weight distribution, degree of cross-linking and gel content may not be critical to the performance as surface coatings. The temperature control is not as important as it is in the case of pressure-sensitive adhesives.

Oligomers

Suitable oligomers are short chains of polymers that are capped with ethylenically unsaturated monomers (i.e. acrylates). Some examples of commercially available oligomers that may be used in the present disclosure are sold under the trade names of Ebycryl (by UCB), Photomer (by Cognis), Laramer (by BASF), and Craynor (by Sartomer).

The viscosity of oligomers is generally high enough so that a thickener is not usually necessary in the present disclosure when oligomers are used.

Comonomers

The monomer can be copolymerized with a copolymerizable monomer capable of producing a (co)polymer without adversely impacting the ability to polymerize the monomer by e-beam radiation at the temperature, residence times, pulse rates and total dose parameters of the disclosure. Suitable comonomers for pressure-sensitive adhesives and coatings include functional polar and nonpolar monomers, including both acidic and basic polar monomers. Such comonomers are preferred in pressure-sensitive adhesives, for example, for the shear properties that result.

A class of suitable comonomers include monoethylenically unsaturated comonomers having homopolymer glass transition temperatures (Tg) greater than about 0° C., preferably greater than 15° C.

Examples of useful polar copolymerizable monomers include, but are not limited to, acrylic acid, methacrylic acid, itaconic acid, N-vinyl pyrrolidone, N-vinyl caprolactam, substituted acrylamides, such as N,N,-dimethyl acrylamide and N-octylacrylamide, dimethylaminoethyl methacrylate, acrylonitrile, 2-carboxyethyl acrylate, maleic anhydride, and mixtures thereof.

Other suitable copolymerizable monomers include acrylate esters or vinyl esters of non-tertiary alkyl alcohols having from 1 to 3 carbon atoms in the alkyl moiety. Examples of such monomers are methyl acrylate, ethyl acrylate, methyl methacrylate, ethyl methacrylate, vinyl acetate, vinyl propionate, and the like. A specific example of a suitable nonpolar monomer is isobornyl acrylate.

Thus, in some presently preferred exemplary embodiments, the at least one polymerizable comonomer is selected from the group consisting of acrylic acid, isobornyl acrylate, octylacrylamide and n-vinyl pyrrolidone.

When a comonomer is employed, the polymerizable composition can include about 70 to about 99 parts by weight, preferably from about 85 to 99 parts by weight acrylate monomer, with the balance being comonomer. The useful amounts of each type of monomer will vary depending upon the desired properties of the pressure-sensitive adhesive or coating and the choice of acrylate and comonomer. For example, when the comonomer is strongly polar, such as acrylic acid or methacrylic acid, a preferred range of comonomer is about 1 to about 15 parts by weight comonomer per 100 parts acrylate monomer and comonomer.

Cross-Linking Agents

In further exemplary embodiments of any of the foregoing, the polymerizable composition further comprises a cross-linking agent. The polymerizable composition may also contain a cross-linking agent to reduce the dose required to achieve adequate cross-linking and/or to further control cross-linking of the adhesive or coating. Useful cross-linking agents include but are not limited to those selected from the group consisting of acrylic or methacrylic esters of diols such as butanediol diacrylate, hexanediol diacrylate, triols such as trimethylolpropane triacrylate, and tetrols such as pentaerythritol acrylate. Other useful cross-linking agents include but are not limited to those selected from the group consisting of polyvinylic cross-linking agents, such as substituted and unsubstituted divinyl benzene, triallylcyanurate and triallyl isocyanurate, di-functional urethane acrylate, such as Ebecryl 270 and Ebecryl 230 (1500 and 5000 weight average molecular weight acrylate urethanes, respectively, both available from Radcure Specialties), and mixtures thereof. When used, the adhesive syrup can typically include up to about 1 parts per hundred (pph), preferably less than about 0.3 pph cross-linking agent. The cross-linking agent can be added at any time prior to coating of the polymerizable composition for a pressure-sensitive adhesive or coating.

Free-Radical Yielding Agent

A free-radical yielding agent capable of efficiently capturing and transferring energy from a higher electron energy state to a lower state may optionally be admixed with the monomer(s), oligomer(s) or blend(s) thereof. The presence of a free-radical yielding agent can improve the rate of polymerization. Suitable free-radical yielding agents are those capable of providing a high yield of free-radicals, capable of providing a sensitizing effect upon acrylate-type monomers, and having a high transfer constant in chain radical reactions. Particularly suitable for use in the present disclosure are halogenated aliphatic hydrocarbons, exemplified by chlorinated saturated C₁₋₃ lower alkanes such as methylene chloride, chloroform, carbon tetrachloride, 1,2-dichloroethane, 1,1-dichlorethane and trichlorobenzene. The effect of the halogenated hydrocarbon is best produced at levels ranging from 0.01 to 5 wt % and preferably 0.1 to 1 wt %.

Photoinitiators

Photoinitiators may be present in the polymerizable composition. However, the photoinitiators contribute little to the chemistry of the polymerizable composition, and survive largely intact for subsequent processes that may be done. They are not necessary, however, for free-radical polymerization using the present disclosure.

Two possible photoinitiators include: 1-hydroxy-cyclohexyl-phenyl-ketone, which goes by the trade name IRGACURE 184, and is available from Sartomer Chemical Co., Westchester, Pa.; and, 2,2-dimethoxy-2-phenylacetophenone, which goes by the trade name IRGACURE 651, and is available from Ciba-Geigy.

Additives

Typical additives, such as fibrous reinforcing agents used in the present disclosure may include fillers, fire retardants, foaming agents, opacifiers, pigments, plasticizers, rheological modifiers, softeners, solvents, stabilizers, tackifiers, ultraviolet protectants, etc. Such additives may be incorporated in the polymerizable composition in the proportions conventionally employed.

Tackifiers

A tackifier can be added to the pressure-sensitive adhesive syrup, or polymerizable composition, for purposes of facilitating coating of the adhesive syrup onto a support prior to polymerization and/or enhancing the adhesive properties of the resultant pressure-sensitive adhesive. Generally useful tackifiers are those that do not contain a significant amount of aromatic structure.

Suitable tackifiers include polymerized terpene resins, cumarone-indene resins, phenolic resins, rosins, and hydrogenated rosins. The adhesive composition can include about 5 to 50 wt % tackifier. Addition of less than about 5 wt % tackifier provides little enhancement in the adhesive strength of the composition, while addition of greater than about 50 wt % reduces both the cohesiveness and the adhesive strength of the composition.

Thickeners

In additional exemplary embodiments of any of the foregoing, the polymerizable composition further comprises a thickener. A thickener may be used in the polymerizable composition of the present disclosure. A thickener may be used with monomers, but are generally not necessary with oligomers. Thickeners can increase the viscosity of the polymerizable composition. The viscosity needs to be high enough to enable the polymerizable composition to be coatable. In addition, the relatively high viscosity may play a role in contributing to the isolation of the free radicals, thereby improving conversion and reducing termination. A viscosity in the range of about 400-25,000 centipoise is typically desired.

Suitable thickening agents are those which are soluble in the polymerizable composition, and generally include oligomeric and polymeric materials. Such materials can be selected to contribute various desired properties or characteristics to resultant article. Examples of suitable polymeric thickening agents include copolymers of ethylene and vinyl esters or ethers, poly(alkyl acrylates), poly(alkyl methacrylates), polyesters such as poly(ethylene maleate), poly(propylene fumarate), poly(propylene phthalate), and the like.

Other types of thickening agents may be used to good advantage include finely divided silica, fumed silica such as CAB-O-SIL, alumina and the like.

Coatings

The polymerizable composition may be coated onto a substrate prior to polymerization by any conventional coating means. Suitable coating techniques include such common techniques as spray coating, curtain coating, solvent casting, latex casting, calendaring, knife coating, doctor blade coating, roller coating, two-roller coating, reverse roller coating, electrostatic coating and extrusion die coating.

It is generally desirable to polymerize the polymerizable composition directly on an end-use substrate. For example, a pressure-sensitive adhesive precursor polymerizable composition can be coated onto a substrate and then subjected to pulses of e-beam radiation so as to form a layer of pressure-sensitive adhesive adherently bonded to a substrate.

Polymerizable composition thicknesses of from about 10 to 500 microns (0.4 to 20 mils) can be conveniently polymerized in accordance with the process described herein at voltages of up to about 300 keV (single gap). Polymerizable composition thicknesses of up to about 1,000 microns (40 mils) can be conveniently polymerized in those situations where the syrup can be irradiated on both sides. Quality control becomes a significant issue with polymerizable composition layers having a thickness of less than about 10 microns (0.4 mil) due to the potential for significant changes in the relative thickness of the layer resulting from selective evaporation. On the other hand, it becomes increasingly difficult to provide consistent levels of polymerization through the entire thickness of polymerizable composition layers which are more than about 500 microns (20 mils) thick due to the limited penetration capabilities of a low voltage e-beam of less than about 300 keV. However, pulsed systems may be capable of higher single gap voltages in a still very compact unit since they do not have to stand off the voltage continuously.

Gap voltage is the electrical potential between the ground and the cathode, which is bridged in a single gap. For DC equipment, this is practical up to a voltage of about 300 keV. Beyond 300 keV, the insulation requirements become very impractical. Higher voltages than 300 keV are generated in multiple gaps to progressively accelerate the electrons emitted from the cathode in steps in order to keep each gap at a manageable potential.

The dielectric requirement needed to insulate a high voltage potential (high voltage stand-off requirement) from ground is greater when the potential is constant than when it is very brief or intermittent. This is because the break-down of insulation properties is not instantaneous but progressive up to a point where arcing can occur (a plasma travels to ground and closes the circuit). The short pulse duration (1-2 microseconds) allows the cathode to discharge before arcing can occur, even when insulation is very modest. This is because the mechanism for discharge is faster than a plasma can close the circuit (rate of travel is a few cm per second). Even at longer pulse durations, the discharge may be faster than the factors that can cause arcing to occur in the 10-100 microsecond time frame, such as finger prints, sharp points and defects on surfaces. Thus, the insulation requirements will not be as great as those required for constant (DC) potential.

Ultimately, heat transfer problems govern the maximum thickness possible. However, a resultant high residual content can be reduced by the subsequent evaporation of residuals from the cured coating. In addition, it becomes increasingly difficult to maintain the appropriate temperature throughout the thickness of the polymerizable composition at thicknesses greater than about 500 microns (20 mils) due to the greater amount of heat generated during polymerization and the slower transfer of heat from the central portion of the polymerizable composition layer.

For pressure-sensitive adhesives, the adhesive syrup (polymerizable composition) can be conveniently coated by conventional coating techniques, such as knife coating and roll coating, at viscosities of between about 500 to 40,000 centipoise. When the resultant polymerized pressure-sensitive adhesive has a viscosity in excess of about 40,000 centipoise, the adhesive composition can be conveniently coated by extrusion or die coating techniques.

The viscosity of the polymerizable composition can be increased to allow the composition to retain a desired coating thickness prior to polymerization. Such an increase in viscosity can be achieved by any of the conventional techniques, including removal of solvent, cooling, effecting partial polymerization of the polymerizable composition, and/or adding thickeners to the polymerizable composition. However, when adding a thickener, care must be taken to ensure that the thickener is not significantly interfering with polymerization or resultant properties, and that the residence time, total dose and/or polymerization temperature are adjusted as appropriate to accommodate inclusion of the thickener. A generally preferred technique for increasing the viscosity of the polymerizable composition, for example, is to prepolymerize approximately 1 to 15 wt %, most preferably about 4 to 7 wt %, of the monomers in the polymerizable composition.

Solventless Blend or Mixture

The polymerizable composition can include a solvent for purposes of facilitating mixing, but is preferably a solvent-free or nearly solvent-free composition of a liquid acrylate-type monomer(s) and any desired copolymerizable monomers. For selected polymerizable compositions for pressure-sensitive adhesives in which solvent is used, for example, it is generally preferred to incorporate about 5-10% of a natural plasticizing solvent, such as water or alcohol, to adjust the viscosity of the composition and enhance the generation of free radicals upon e-beam irradiation of the composition.

Emulsion

An advantage of the present disclosure is that it is versatile. As discussed above, the polymerizable composition may be solventless. However, a polymerizable composition that is an emulsion may also be polymerized using the present disclosure. The emulsion may be coated on-web, then polymerized using the present disclosure, and then subsequently dried.

### Articles Made Using Scanned, Pulsed E-Beam Polymerization

Pressure-Sensitive Adhesives

Pressure-sensitive adhesives must generally balance several competing properties (e.g., tackiness, peel strength, creep resistance, cohesiveness, etc.) in order to meet the requirements of the particular end use to which the adhesive is to be employed. The properties of a pressure-sensitive adhesive are primarily affected by monomer composition, molecular weight and cross-link density. For example, monomer composition generally determines the glass transition temperature (T_{g}), bulk properties and surface chemistry of the adhesive, all of which affect adhesion. With respect to polymers having a sufficient cross-link density, higher molecular weights normally result in better cohesion. Cohesion can also be increased by increasing the degree of covalent cross-linking between ionically bonded polymers and secondary intermolecular bonding.

High gel content provides the desired properties for a pressure-sensitive adhesive. For example, high gel content provides good creep-resistance, and high shear properties.

Pressure-sensitive adhesives with high conversion are particularly important for adhesives intended for medical, optical and electronic applications, where even small amounts of residual monomer may irritate the skin, inhibit the transmission of light and/or damage or corrode metal parts.

Under the present disclosure, acrylate pressure-sensitive adhesives having superior peel adhesion and shear strength with high conversion can also be obtained, without the use of solvents, by e-beam copolymerization of the acrylate pressure-sensitive adhesive syrup with pulses of accelerated electrons of defined dose, residence time and pulse rate ranges. The present disclosure can, when properly optimized, achieve the same results for the adhesive as the continuous electron beam at about the same dose level but in only 2 seconds of residence time, as opposed to about 5 seconds. This is a great advantage in allowing a continuous process to be run at a more rapid pace.

Pressure-sensitive adhesives produced in accordance with the e-beam process described herein can possess desirable adhesive properties and characteristics, including good shear strength and peel adhesion, with high conversion. Generally, acrylate pressure-sensitive adhesives can be produced having a peel adhesion of at least 25 N/dm, frequently over 55 N/dm, and a shear strength, or shear adhesion time, of at least 300 minutes, frequently over 10,000 minutes, with a conversion of greater than about 90 wt %, frequently greater than about 97 wt %. In addition, pressure-sensitive adhesives can be produced having a gel content of greater than 80 wt %, frequently greater than 95 wt %.

Coatings

The present disclosure can also be used, more generally, to polymerize coatings. One such example of a coating is a hard coat to protect surfaces. Coatings are coated onto substrates to protect such substrates from physical damage like scratches, abrading and the like. The coatings may also be used to improve the physical appearance of the surface that is coated. The substrates that may be coated by a coating include anything that is dry to the touch. Examples of such substrates include, but are not limited to, films used in manufacturing traffic signs, graphic display media (e.g. billboards and advertising displays), window glass tinting and protection films, automotive glass tinting films, solar reflective and solar photovoltaic films, and the like.

In certain exemplary embodiments, the substrate is a web moving in a down-web direction and having a width in a cross-web direction substantially orthogonal to the down-web direction, further wherein scanning the first electron-beam across at least a portion of the coated surface comprises scanning the electron-beam in the cross-web direction, scanning the electron-beam in the down-web direction, and combinations thereof.

In some exemplary embodiments of any of the foregoing, scanning the first electron-beam across the coated surface produces a plurality of irradiated regions of the polymerizable composition, optionally wherein each of the plurality of irradiated regions is surrounded by a non-irradiated region of the polymerizable composition. This may facilitate the formation of structures or features formed by the at least partially polymerized polymerizable composition on the major surface of the substrate. In further exemplary embodiments, the non-irradiated region of the polymerizable composition may be removed (e.g. by washing with a solvent which dissolves the polymerizable composition but not the at least partially polymerized composition).

### Unexpected Advantages

Exemplary embodiments of the present disclosure have advantages over use of other types of irradiation (e.g. gamma radiation, ultraviolet radiation, and the like), as well as a continuous e-beam or a non-scanned pulsed e-beam. One such advantage of exemplary embodiments of the present disclosure is that the polymerization process is effective for quickly and efficiently producing polymers having a sufficient cross-link density. One use for such cross-linked polymers is in a pressure-sensitive adhesive composition requiring superior peel adhesion and superior shear strength and high conversion, which does not require the use of solvents or chemical initiators for the conversion process to take place.

A second advantage of at least one exemplary embodiment of the present disclosure is that the deposition of energy by the pulses of accelerated electrons, under certain conditions (e.g. low dose/pulse and high pulse rate), is heterogeneous in nature. Heterogeneous polymerization (polymerization in heterogeneous mode or fashion) occurs when free radicals are localized (non-random) by any of several mechanisms involving different states of matter or phase separation within a given state of matter in order to restrict their diffusion. This has the effect of limiting termination reactions. In homogeneous polymerization, the diffusion of monomer to the free radicals is not restricted. Termination results from a propagating free radical being joined by another free radical, rather than a monomer, to effectively end propagation. The two unpaired electrons combine to form a single bond.

The ionization events, in heterogeneous polymerization, are distributed at some distance from one another as isolated sites where free radicals emerge as surviving species before diffusion causes the system to become homogeneously distributed. This effectively allows polymerization to take place and reduces termination because the free radicals are separated from each other spatially for a short time period. The reduction in termination results in higher conversion values for the polymerization method.

Homogeneous polymerization (or polymerization in a homogeneous fashion or mode), on the other hand, is polymerization in which the free radicals are distributed randomly in a single-phase medium and are free to diffuse. The termination that results is governed by the thermodynamics of molecular movement (which is continuous, thermally-driven random motion of the molecules caused by impact with other molecules of the liquid). Termination effectively occurs more easily and quickly in homogeneous polymerization than in heterogeneous polymerization.

An additional advantage of at least those embodiments which use a pulsed electron-beam source is the ability to irradiate discrete regions of a polymerizable composition on a major surface of a substrate, thereby facilitating the formation of a plurality of discrete irradiated regions of the polymerizable composition wherein each of the plurality of irradiated regions is adjacent to (and preferably surrounded by) a non-irradiated region of the polymerizable composition on the substrate. This may facilitate the formation of structures or features formed by the at least partially polymerized polymerizable composition on the major surface of the substrate. This may also facilitate the formation of a patterned or textured surface on the substrate, formed by the irradiated (at least partially polymerized) polymerizable composition (e.g. after removal of any non-polymerized polymerizable composition, for example, by washing with a solvent which dissolves the polymerizable composition but not the at least partially polymerized composition.

Another advantage of at least one embodiment of the present disclosure is that the residence time needed to produce an article using the method is shorter, because of reduced terminations, than using the other methods of irradiation or a continuous beam of electrons. This means that more practical throughput rates can be achieved.

A further advantage of at least one embodiment of the present disclosure is that pulsing the electron-beam decreases the high voltage hold-off (i.e. using more robust insulation around the cathode and high voltage components) required by continuous e-beams to prevent internal arching. Therefore, there may be the opportunity to lower capital cost to build equipment by using less expensive components and more compact vessels.

An additional advantage, in some exemplary embodiments, is the tolerance for longer or wider pulse duration or pulse width than is typical of thyratron types of pulse forming equipment (1-2 microseconds). The tolerance of pulse durations of about 1-250 microseconds allows latitude in the choice of pulse-forming networks which include less expensive, more conventional capacitor-discharge types. Also, there is less thermal shock experienced by the beam window at the wider pulse-width.

Another advantage in at least one exemplary embodiment over, for example, an ultraviolet radiation induced polymerization process, is that a clean and clear adhesive can be made without the photoinitiators or triazine residues. Also, highly pigmented adhesives can be produced that would not be able to be produced using ultraviolet (UV) radiation sources (e.g. UV curing) because highly pigmented adhesives are generally opaque to UV light.

Yet another advantage of at least one embodiment of the present disclosure is that it allows for polymerization of materials with short stability times, because the process is so fast. For instance, polymerization of a mixture of two immiscible materials is possible. The mixture can be polymerized after it has been mixed and before it has a chance to phase separate. In addition, polymerization of thin layers of materials that evaporate quickly after being coated is also possible. Further, because temperature control can be practically maintained throughout the short time period necessary for polymerization, it is possible to polymerize biphase compositions with novel morphology or topology.

An additional advantage of exemplary embodiments of the present disclosure is that there are fewer contaminants than with other processes. In other processes for making a pressure-sensitive adhesive, for example, catalysts or initiators are used to make the adhesive. The initiator, or parts of it, remains in the adhesive that is formed using the initiator. It is important, in the electronics industry, for example, to keep these contaminants to a minimum. When adhesives, for example, are used in or near electronics, any contaminants in the adhesives or out-gas may cause undesirable reactions in the electronics, such as corrosion. The pulsed e-beam process does not use initiators, and, therefore, eliminates this problem.

One more advantage of at least one exemplary embodiment of the present disclosure is that it is versatile. For example, the method may be used to polymerize solventless blends as well as emulsions, which may be coated on-web and then polymerized.

Exemplary embodiments of the present disclosure have been described above and are further illustrated below by way of the following Examples, which are not to be construed in any way as imposing limitations upon the scope of the present invention. On the contrary, it is to be clearly understood that resort may be had to various other embodiments, modifications, and equivalents thereof which, after reading the description herein, may suggest themselves to those skilled in the art without departing from the spirit of the present disclosure and/or the scope of the appended claims.

### EXAMPLES

The following examples are intended to illustrate exemplary embodiments within the scope of this disclosure. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Testing Procedures

The following tests have been used to evaluate polymerized compositions of the disclosure.

Conversion

A 14.5 cm² (1.5 in×1.5 in square) sample was die-cut from the irradiated substrate and the release liner removed and discarded. The uncovered sample was weighed (Sample Wt_{Before}), placed in an oven for 2 hours at 100° C., and then weighed again (Sample Wt_{After}). A 14.5 cm² sample of uncoated substrate was also die-cut and weighed (Substrate Wt). The percent conversion (% Conv) was calculated in accordance with the equation provided below:

% Conv=(Sample Wt_{After}−Substrate Wt)(100)/(Sample Wt_{Before}−Substrate Wt)

Gel Percent

A tape sample was die cut into a square having an area of about 14.5 cm². The release liner was then peeled by hand from the pressure-sensitive adhesive (PSA) tape. The PSA tape sample was placed in a pre-weighed aluminum pan (m0), weighed (m1), then submerged in ethyl acetate in a Nalgene container for 16 hours to extract dissolvable reactants from the polymerized coating. The sample portion was then removed, placed in the pan and dried for 120 minutes in an oven set at 60° C., allowed to cool to room temperature, and weighed (m2). The gel percent was calculated by the following formula:

Gel %=(m2−m0)(100)/(m1−m0).

Results are for each sample and are reported to the nearest whole number.

### Materials Used

The following terminology, abbreviations, and trade names are used in the examples:

| | Trade Name | |
|---|---|---|
| Type | or Acronym | Description |
| (Meth)acrylate | IOA | 2-octyl acrylate, available from Sartomer Chemical |
| monomer | | Co., Westchester, Pennsylvania. |
| (Meth)acrylate | 2-EHA | 2-ethylhexyl acrylate, available from Sartomer |
| monomer | | Chemical Co., Westchester, Pennsylvania |
| Copolymerizable | AA | Acrylic acid, available from Aldrich Chemical Co., |
| material | | St. Louis, Missouri. |
| Photoinitiator | IRGACURE | 2,2-dimethoxy-2-phenylacetophenone, available from |
| | 651 | Ciba-Geigy. |
| Cross-linking | HDODA | 1,6-hexanedioldiacrylate available from UCB |
| agent | | Chemicals Corporation, Smyrna, Georgia. |
| Silicone | PDMS | Polydimethylsiloxane, XIAMETER OHX-4070, |
| | | 50,000 cSt, available from Dow Corning Silicones, |
| | | Midland, MI |
| Substrate | Treated PET | Polyethylene terephthalate film chemically treated an |
| | | aminated polybutadiene priming agent, 38 |
| | | micrometers thick. |
| Release liner | | Silicone-coated PET. |

Throughout the Examples, the Specification and the Claims, all parts, percentages, and ratios are by weight unless otherwise indicated. Parts of any precursor emulsion components, other than reactive materials, are based on 100 parts by weight of the reactive materials. Most measurements were recorded in English units and converted to SI units.

### Exemplary E-Beam Processes

Scanned, pulsed e-beam polymerization experiments were carried out using the apparatus as shown in FIG. 1A. The e-beam source, a nested high-voltage generator (NHVG) developed by Applied Energetics, Inc. (Tucson, Ariz.), generates a focused electron-beam that is then sent through a quadrupole to improve the beam optics, bent around a bend magnet, and finally scanned as it enters the vacuum chamber.

The e-beam was characterized by the size (diameter) of the e-beam, as well as its cross-web scanning characteristics based on various scan parameters. The following parameters were used for all of the scanned, pulsed e-beam polymerization experiments listed below:

X: 25 cm

Y: 22 cm

L: 22 cm

D: 3 cm

fₓ: 33 kHz

f_{y}: 950 Hz

I: 0.3-0.5 mA

V: 165 kV

Thus, the exposure duration, tₒₙ=D/vₓ=D/(fₓX)=3/(33000*25) sec=3.6 μsec in the scanned, pulsed e-beam polymerization examples below.

A pressure-sensitive adhesive precursor syrup consisting of 90 wt % of acrylate monomer (IOA), 10 wt % copolymerizable material (AA) and 0.04 pph of a photoinitiator was made according to U.S. Pat. No. 5,028,484, Ex. 19-26. The mixture was partially photopolymerized in an inert nitrogen atmosphere by ultraviolet light irradiation to form an original coatable adhesive syrup having a Brookfield viscosity of about 450 centipoise (cP).

A modified syrup was also made by incorporation of sufficient additional copolymerizable material, AA, to change the weight ratio of IOA:AA to 88:12 to minimize effects of possible evaporation of AA during processing. A cross-linking agent (HDODA), was either added at an amount of 0.3 parts per 100 parts of modified 88:12 syrup to make Syrup A or at a similar amount to the original 90:10 syrup to make Syrup B.

### Comparative Example 1

Comparative examples of pulsed electron beam polymerization using were prepared by polymerizing 2-EHA at 500 Hz and 50 Gy/pulse. Syrup A was coated with a knife-coater onto treated PET film at a nominal coating thickness of 2 mils or 50 micrometers (μm). The pulse duration was varied from 20 microseconds, 15 microseconds, 10 microseconds, and 2 microseconds. Details of these comparative examples are provided in and U.S. Pub. Pat. App. No. 2003/0031802, and in the Ph.D. dissertation of K. Benjamin Richter, Dept. of Chemical Engineering and Material Science, University of Minnesota (2007).

FIG. 2 is a graph of the monomer fractional conversion as a function of the total electron-beam dose obtained in exemplary comparative examples of pulsed electron-beam polymerization using the four different pulse durations.

### Example 1

### Pressure Sensitive Adhesives

Pressure-sensitive adhesive samples were made by scanned, pulsed electron-beam irradiation at 0° C. temperature using syrup A. Each sample was coated using a Meyer rod to a thickness of about 1 mil (25 micrometer thick) and sandwiched between two layers of 1 mil (25 micrometer thick) polyethylene terephthalate film (PET).

Each coated sample was measured for conversion percent and gel percent. Example 1 illustrates the effect of dose per exposure duration on total dose necessary to obtain an extrapolated conversion of at least 90%, and more preferably at least about 95% or higher (e.g. 94.4% to 99.7%). Example 1 also illustrates the effect of dose per exposure duration on total dose to obtain an extrapolated gel percent of at least about 80%, more preferably at least about 90% or even at least about 95% (e.g. 97-99.1%), but preferably less than 100%.

Table 1 shows a summary of samples (identified as PEB-001; PEB-002, PEB-003; PEB-004; PEB-005; and PEB-006), that were generated using the scanned, pulsed e-beam settings described above, and comparative examples (identified as PEB-007; PEB-008; PEB-009; PEB-010; PEB-011; PEB-012; PEB-013; PEB-014; PEB-015; PEB-016; and PEB-017) irradiated with a continuous e-beam (CB-300).

TABLE 1
Summary of Irradiation of Coated Acrylate Syrup A
Using Scanned, Pulsed and Continuous E-Beam Polymerization

| | | | | Pre-bake | Post-bake | | Pre | Post | | |
|---|---|---|---|---|---|---|---|---|---|---|
| | | Dose | Web Speed | Weight (W1) | Weight (W2) | Conversion | Extraction | Extraction | | |
| Type | Sample | (Mrad) | (fpm) | (mg) | (mg) | (%) | (mg) | (mg) | Notes | Gel |
| Pulsed | PEB-001 | ? | 0.5 | 181.3 | 174.6 | 81.2 | Too converted - sample would not | | | |
| | | | | | | | peel apart completely and a fragment | | | |
| | | | | | | | may be missing. | | | |
| Pulsed | PEB-002 | 11.8 | 0.5 | 186.5 | 185.0 | 96.3 | Hard to peel as well. Unreliable. | | | |
| | | | | | | | Not sure of dose. | | | |
| Pulsed | PEB-008 | 6.74 | 0.5 | 180.5 | 180.4 | 99.7 | 2184.3 | 2184.1 | 2 liners | 99.1 |
| Pulsed | PEB-003 | 3 | 1 | 188.5 | 187.5 | 97.7 | 5746.7 | 5746.4 | 1 liner | 97.0 |
| Pulsed | PEB-005 | 1.63 | 2 | 179.0 | 174.2 | 85.6 | 2184.3 | 2183.8 | 1 liner | 84.1 |
| Pulsed | PEB-007 | 0.58 | 6 | 178.7 | 160.1 | 43.8 | 2244.3 | 2232.8 | 2 liners | 9.1 |
| Pulsed | PEB-006 | 0.58 | 4 | 184.8 | 160.5 | 38.0 | 2266.8 | 2264.4 | 2 liners | 31.9 |
| Continuous | PEB-010 | 0.4 | 72 | 179.2 | 147.8 | 6.5 | 2275.8 | 2274.2 | 2 liners | 1.8 |
| Continuous | PEB-011 | 0.8 | 36 | 183.0 | 157.8 | 32.6 | 2278.0 | 2263.1 | 2 liners | −7.2 |
| Continuous | PEB-012 | 1.6 | 18 | 182.1 | 162.9 | 47.3 | 2200.8 | 2194.6 | 2 liners | 30.4 |
| Continuous | PEB-013 | 3.2 | 9 | 183.0 | 173.8 | 75.4 | 2280.0 | 2270.6 | 2 liners | 50.3 |
| Continuous | PEB-014 | 6.4 | 9 | 182.1 | 177.3 | 86.8 | 2358.4 | 2354.3 | 2 liners | 75.6 |
| Continuous | PEB-015 | 12.8 | 9 | 185.2 | 183.0 | 94.4 | 2283.9 | 2279.6 | 2 liners | 83.6 |
| Continuous | PEB-016 | 3.2 | 18 | 184.9 | 164.1 | 47.0 | 2237.3 | 2230.2 | 2 liners | 29.0 |
| Continuous | PEB-017 | 3.2 | 36 | 185.5 | 168.3 | 56.9 | 2301.8 | 2287.0 | 2 liners | 19.8 |

The gel measurements in the last column of Table 1 show the gel content to be higher in the scanned, pulsed e-beam polymerization samples than in continuous e-beam exposure polymerization samples for similar doses, as would be expected from a more efficient polymerization with much lower residuals content, as obtained using scanned, pulsed e-beam polymerization.

FIG. 3 is a graph of the monomer fractional conversion as a function of total electron-beam dose obtained from the examples and comparative examples of Table 1, comparing scanned, pulsed electron-beam polymerization with continuous electron-beam polymerization. The fractional conversion is higher for scanned, pulsed e-beam polymerization than continuous e-beam polymerization over the dose range from about 10 Gy to about 80 Gy or higher.

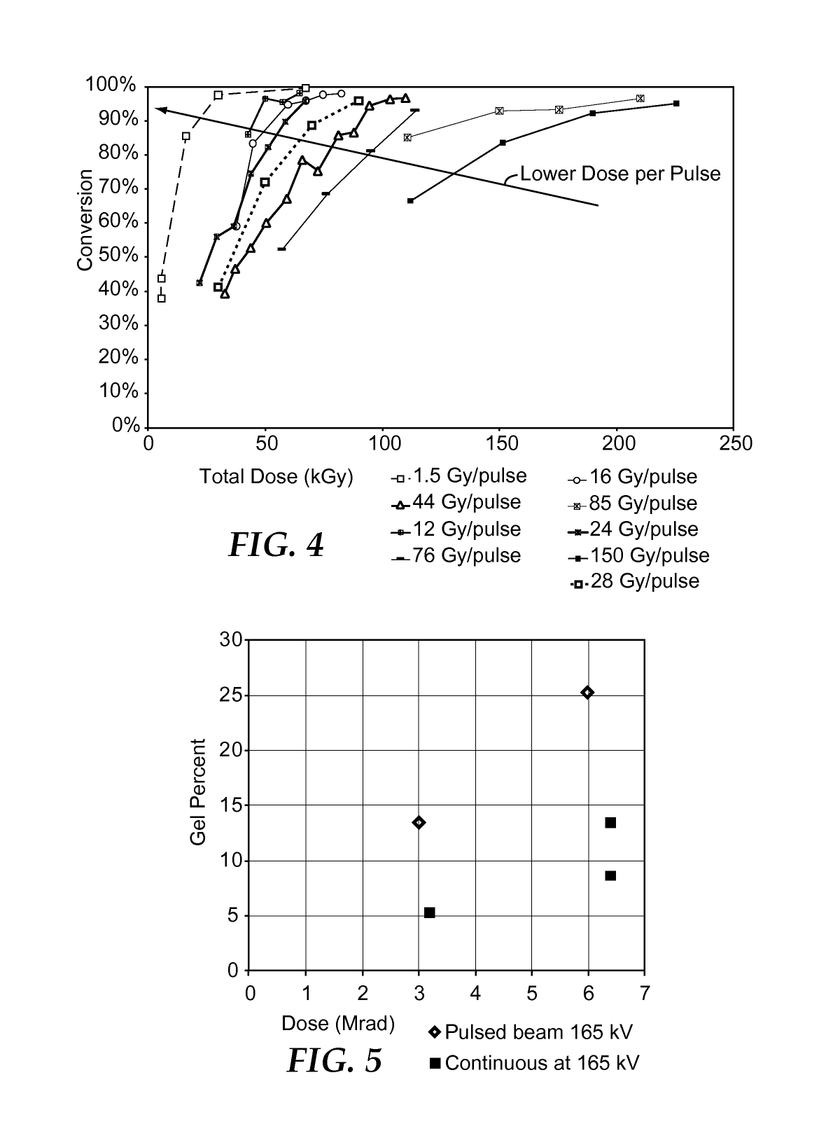

FIG. 4 is a graph of the monomer fractional conversion as a function of total electron-beam dose obtained in comparing exemplary embodiments of scanned, pulsed electron-beam polymerization (1.5 Gy/pulse) versus pulsed e-beam polymerization (12 Gy/pulse and higher) using different dose/pulse levels.

FIG. 5 is a graph of gel percent as a function of total electron-beam dose obtained in exemplary embodiments comparing scanned, pulsed electron-beam polymerization at 165 kV with a control continuous electron-beam polymerization at 165 kV. The gel percent is higher at any given dose at the same e-beam voltage.

### Example 2

### Silicone Cross-Linking

The sample conditions described above were also used to cross-link non-functional PDMS (OHX-4070, 50,000 cSt) that was coated to a thickness of 3 mils (75 micrometers) on PET. Table 2 summarizes the experimental conditions and results of the cross-linking (gel percent).

TABLE 2
Summary of Radiation Cross-linking of PDMS
Using Scanned, Pulsed or Continuous E-beam Polymerization

| | | Dose | Web Speed | Beam Current | Beam Voltage | | Average |
|---|---|---|---|---|---|---|---|
| Sample Name | Beam Type | (Mrad) | (fpm) | (mA) | (kV) | Gel % | Gel % |
| PEB-004 | Pulsed | 3.0 | 1.0 | 0.31 | 165 | 10.7 | 13.4 |
| PEB-004 | Pulsed | 3.0 | 1.0 | 0.31 | 165 | 16.2 | |
| PEB-009 | Pulsed | 6.0 | 0.5 | 0.39 | 165 | 25.4 | 25.2 |
| PEB-009 | Pulsed | 6.0 | 0.5 | 0.39 | 165 | 24.9 | |
| PEB-019 | Continuous | 3.2 | 9.0 | 1.0 | 165 | 5.2 | 5.2 |
| PEB-019 | Continuous | 3.2 | 9.0 | 1.0 | 165 | 5.3 | |
| PEB-020 | Continuous | 6.4 | 9.0 | 2.0 | 165 | 9.2 | 13.4 |
| PEB-020 | Continuous | 6.4 | 9.0 | 2.0 | 165 | 17.5 | |
| PEB-021 | Continuous | 6.4 | 18.0 | 4.0 | 165 | 8.3 | 8.6 |
| PEB-021 | Continuous | 6.4 | 18.0 | 4.0 | 165 | 8.8 | |

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. Furthermore, all publications, published patent applications and issued patents referenced herein are incorporated by reference in their entirety to the same extent as if each individual publication or patent was specifically and individually indicated to be incorporated by reference. Various exemplary embodiments have been described. These and other embodiments are within the scope of the following listing of disclosed embodiments.

1. A method comprising:
a. coating at least a portion of at least one major surface of a substrate with a polymerizable composition to obtain a coated surface;
b. initiating polymerization of the polymerizable composition by scanning a first electron-beam focused on the coated surface across at least a portion of the coated surface, thereby irradiating the coated surface at a scanning frequency selected to achieve an exposure duration of greater than 0 and no greater than 10 microseconds per scan, and a dark time between each exposure duration of at least one millisecond, thereby producing an at least partially polymerized composition.

2. The method of claim 1, further comprising further irradiating the coated surface with a continuous beam of accelerated electrons from a continuous electron-beam source to further polymerize the at least partially polymerized composition, optionally wherein at least one of irradiating the coated surface and further irradiating the coated surface occurs at a temperature below 20° C.

3. The method of claim 1, wherein the first electron-beam is a pulsed electron-beam.

4. The method of claim 3, wherein a pulse rate of the first electron-beam is from about 25 to about 3,000 pulses per second.

5. The method of claim 1, wherein scanning the first electron-beam across the coated surface produces a plurality of irradiated regions of the polymerizable composition, optionally wherein each of the plurality of irradiated regions is surrounded by a non-irradiated region of the polymerizable composition.

6. The method of claim 1, wherein the first electron-beam is a continuous electron-beam.

7. The method of claim 1, wherein the exposure duration is from about 0.5 to about 2 microseconds per scan.

8. The method of claim 1, wherein the first electron-beam delivers an electron-beam dose per exposure duration between 0 and 10 Gy.

9. The method of claim 1, wherein the substrate is a web moving in a down-web direction and having a width in a cross-web direction substantially orthogonal to the down-web direction, further wherein scanning the first electron-beam across at least a portion of the coated surface comprises scanning the electron-beam in the cross-web direction, scanning the electron-beam in the down-web direction, and combinations thereof.

10. The method of claim 1, wherein the polymerizable composition comprises at least one polymerizable monomer, at least one oligomer, or a combination thereof.

11. The method of claim 10, wherein the at least one polymerizable monomer comprises a C₈₋₁₃ alkyl acrylate monomer.

12. The method of claim 11, wherein the C₈₋₁₃ alkyl acrylate is selected from the group consisting of 2-octyl acrylate, 2-ethylhexyl acrylate, lauryl acrylate and tridecyl acrylate.

13. The method of claim 10, wherein the at least one polymerizable monomer is selected from the group consisting of methyl methacrylate, isobornyl acrylate, tripropyleneglycol diacrylate, pentaerythritol triacrylate, pentaeryritol tetraacrylate, hydantoin hexacrylate, and trimethylolpropylenetriacrylate.

14. The method of claim 10, wherein the polymerizable composition further comprises at least one polymerizable comonomer.

15. The method of claim 14, wherein the at least one polymerizable comonomer is selected from the group consisting of acrylic acid, isobornyl acrylate, octylacrylamide and n-vinyl pyrrolidone.

16. The method of claim 1, wherein the polymerizable composition further comprises a cross-linking agent.

17. The method of claim 1, wherein the polymerizable composition further comprises a thickener.

18. The method of claim 1, wherein the polymerizable composition is polymerized heterogeneously in a single phase.

19. The method of claim 1, wherein the conversion of the polymerizable composition is greater than 90%, optionally wherein the gel percent is greater than 95%.

20. An article made according to claim 1, wherein the article is selected from a pressure sensitive adhesive article, a cross-linked silicone release liner, or a combination thereof.
